(19) United States
(12) Patent Application Publication
(10) Pub. No.: US 2026/0192557 A1
(43) Pub. Date: Jul. 9, 2026

(54) CONFORMABLE, RECYCLABLE SHIPPING CONTAINER MATERIALS

(71) Applicant: PAC WORLDWIDE CORPORATION, Redmond, WA (US)

(72) Inventors: Brian Andrew Kendall, Maineville, OH (US); William Lane, Hamilton, OH (US); Murray Fullerton, Pukekohe (NZ); James Arne Boshaw, Bellevue, WA (US); Yvon Mongrain, Lanoraie (CA)

(21) Appl. No.: 19/555,318

(22) Filed: Mar. 3, 2026

Related U.S. Application Data
(63) Continuation of application No. PCT/US2024/045215, filed on Sep. 4, 2024.
(60) Provisional application No. 63/580,635, filed on Sep. 5, 2023.
(60) Provisional application No. 63/597,609, filed on Nov. 9, 2023.

(51) Int. Cl. B32B 29/08; B32B 3/26; B32B 7/12; B32B 29/00

(52) U.S. Cl. CPC B32B 29/08; B32B 3/266; B32B 7/12; B32B 29/005; B32B 2250/02; B32B 2250/26; B32B 2255/12; B32B 2307/31; B32B 2307/7375; B32B 2553/00

(57) ABSTRACT

The present disclosure is directed to a shipping container with a corrugated medium that lines an interior pocket of the shipping container as well as devices. The corrugated medium has flutes that cushion, support, and protect a product that is shipped within the shipping container. The corrugated medium may include a first portion with first flutes and a second portion with second flutes that are offset relative to the first flutes. The offset first flutes and second flutes results in peaks of the first flutes nesting within valleys of the second flutes, and peaks of the second flutes nesting within valleys of the first flutes.

### CROSS REFERENCE TO RELATED APPLICATIONS

This application is a bypass continuation of International Application No. PCT/US2024/045215 filed Sep. 4, 2024, which claims the benefit of U.S. Provisional Application No. 63/597,609 filed Nov. 9, 2023, and U.S. Provisional Application No. 63/580,635 filed Sep. 5, 2023. Each of the foregoing applications is hereby incorporated herein by reference in its entirety.

### BACKGROUND

### Technical Field

The present disclosure is directed to embodiments of shipping containers and materials for use in shipping containers.

### Description of the Related Art

Retailers (e.g., online retailers, brick-and-mortar retailers, specialty retailers, etc.) ship thousands of products that are sold to buyers and consumers on a regular basis either in-person, over the phone, or through a website. These products (e.g., an object, an item, an electronic device, a candle, an article of clothing, a beverage can, a beverage container, etc.) come in any number of different shapes or sizes. Some of these products, such as candles, may come in outer containers such as a jar, which may be made of glass. These products are placed within a conventional shipping container that protects the product, reducing a likelihood of the product breaking during shipping.

Shipping costs of these products utilizing conventional shipping containers to ship the products may be determined by a total volume of a conventional shipping container and a product within the conventional shipping container. As shipping costs may be determined by volume, retailers try to utilize conventional shipping containers that are relatively flat and only slightly larger than the product itself to reduce the total volume of the product and the conventional shipping container.

Shipping costs of these products utilizing conventional shipping containers to ship the products may be determined by a total weight of a conventional shipping container and a product within the conventional shipping container. As shipping costs may be determined by weight, retailers utilize conventional shipping containers that are lightweight. For example, retailers may utilize conventional shipping containers known as conventional bubble mailers to ship or send products to customers. Usually, conventional bubble mailers are made of multiple materials, such as paper and plastic.

Since these conventional bubble mailers are made of plastic and paper, these bubble mailers can be recycled if the components or materials are manually separated and delivered to a recycling facility that recycles the components or materials. However, most customers, consumers, or buyers are unaware that these materials must be separated to be properly recycled, which results in many conventional bubble mailers used today ending up in landfills.

The conventional bubble mailers have air bubbles within the conventional bubble mailers. These air bubbles cushion and protect the product in the conventional bubble mailer, reducing the likelihood of the product breaking when being shipped to the consumer, customer, or buyer.

In some other conventional shipping containers, a plurality of flutes may be present internally within the conventional shipping container, reducing a likelihood of the product breaking while shipping the product to the consumer, customer, or buyer. In other words, similar to the air bubbles of the bubble mailer, the flutes cushion and protect the product during shipping.

As products shipped by retailers come in many different sizes and shapes (e.g., cylindrical, square, rectangular, triangular, etc.), retailers generally buy and store a few standard-sized conventional shipping containers to ship these products to a buyer. For example, a retailer may buy and store first conventional shipping containers having a first volume as well as second conventional shipping containers with a second volume that is larger than the first volume. In other words, the first shipping containers may be utilized to ship smaller objects relative to larger objects shipped in the second shipping containers.

Storage costs for storing conventional shipping containers increase as the conventional shipping containers become larger. For example, the cost of storing the first conventional shipping containers is smaller relative to the cost of storing the second conventional shipping containers as the first conventional shipping containers are smaller than the second conventional shipping containers.

These storage costs increase as a number of conventional shipping containers to be stored increases. For example, a larger retailer that ships a greater number of products relative to a smaller retailer may have a greater number of conventional shipping containers that must be stored relative to the smaller retailer. In this situation, the larger retailer would usually have greater storage costs relative to the smaller retailer as the larger retailer is storing a greater number of the conventional shipping containers. In other words, these storage costs are determined by an amount of volume taken up by the shipping containers when stored and waiting to be utilized to ship a product out to the consumer, customer, or buyer.

Similar to how shipping costs of a product in a conventional shipping container are determined by volume, weight, or a combination of both, shipping costs of empty shipping containers to a retailer is determined by volume, weight, or a combination of both. For example, usually, the conventional shipping containers are shipped in the least number of boxes and containers as possible to the retailer to reduce shipping costs of the conventional shipping containers themselves. As the number of boxes or containers holding the conventional shipping containers increases when shipping the conventional shipping containers to the retailer, the shipping costs to ship the conventional shipping containers themselves increases as well.

### BRIEF SUMMARY

The present disclosure is directed to at least one embodiment of a shipping container that includes at least a corrugated medium having a plurality of flutes adhered to an outer liner. The corrugated medium and outer liner are configured to be selectively bent and folded in directions aligned and not aligned with flutes of the corrugated medium. This bendability or flexibility of the corrugated medium with the flutes enables the corrugated medium and the outer liner to easily and closely conform to a product placed adjacent to the corrugated medium. In other words, the shipping container of the present disclosure readily conforms to the shape of the product.

In some embodiments, to provide the shipping container of the present disclosure with the bendability, foldability, and, ultimately, conformability, such that the shipping container of the present disclosure more readily conforms to a product, the corrugated medium may have a plurality of score lines that extend along, across, and through the plurality of flutes of the corrugated medium. These scoring lines increase the bendability, the flexibility, the foldability, and the conformability of the flutes and the shipping containers of the present disclosure as a whole.

This greater bendability, foldability, and conformability allows the shipping containers of the present disclosure to readily conform to a product positioned within the shipping containers of the present disclosure. This ability of the shipping containers of the present disclosure to conform to the shape of the products placed in the shipping containers reduces the shipping costs of the product. For example, a first total volume of the product and one of the shipping containers of the present disclosure in which the product is present is less than a second total volume of the same product in shipping containers that does not implement embodiments of the present disclosure. Therefore, shipping the product in one of the shipping containers of the present disclosure costs less than shipping the same product in shipping containers that does not implement embodiments of the present disclosure.

A system may be summarized as comprising: a single-faced corrugated material including a corrugated medium coupled to an outer liner; wherein a surface of the corrugated material opposite to the outer liner is coated by a water-based heat-seal coating. The corrugated medium may include a center score line, edge score lines, and/or a diamond score pattern. Flutes of the corrugated medium may include slits through the corrugated medium. The single-faced corrugated material may be made from paper materials. The corrugated medium and the outer liner may not include any plastic materials.

A package may be summarized as comprising: a sheet of a single-faced corrugated material including a corrugated medium coupled to an outer liner, wherein a surface of the corrugated material opposite to the outer liner is coated by a water-based heat-seal coating, wherein the sheet is folded along a fold line to form a first layer on a first side of the fold line and a second layer on a second side of the fold line, and wherein the fold line forms a first edge of the package; wherein the first layer is sealed to the second layer by the water-based heat seal coating along a second edge of the package, a third edge of the package, and a fourth edge of the package.

A first portion of the corrugated medium may be coupled to a second portion of the corrugated medium at the second edge of the package, a third portion of the corrugated medium may be coupled to a fourth portion of the corrugated medium at the third edge of the package, and a fifth portion of the corrugated medium may be coupled to a sixth portion of the corrugated medium at the fourth edge of the package. The corrugated medium may include a center score line and the fold line may extend along the center score line. The corrugated medium may include edge score lines and the edge score lines may be at the third edge of the package, wherein the third edge of the package is opposite to the first edge of the package. The corrugated medium may include a diamond score pattern. Flutes of the corrugated medium may include slits through the corrugated medium. The single-faced corrugated material may be made from paper materials. The corrugated medium and the outer liner may not include any plastic materials.

A system may be summarized as comprising: a roll of a single-faced corrugated material including a corrugated medium coupled to an outer liner; wherein a surface of the corrugated material opposite to the outer liner is coated by a water-based heat-seal coating.

An entirety of the surface of the corrugated material opposite to the outer liner may be coated by the water-based heat-seal coating. The water-based heat seal coating may not coat an entirety of the surface of the corrugated material opposite to the outer liner, and the water-based heat seal coating may be zone-coated on the surface of the corrugated material opposite to the outer liner. The single-faced corrugated material may have an overall length of at least ten feet, at least fifty feet, or at least one hundred feet.

### BRIEF DESCRIPTION OF THE SEVERAL VIEWS OF THE DRAWINGS

FIGS. 1A-1D are directed to an embodiment of a shipping container containing a product.

FIG. 1E is directed to the embodiment of the shipping container as shown within FIGS. 1A-1D without the product.

FIG. 2 is directed to an embodiment of a blank for forming an alternative embodiment of a shipping container.

FIG. 3 is directed to alternative embodiments of blanks for forming an alternative embodiment of a shipping container.

FIGS. 4A-4D are directed to an alternative embodiment of a blank for forming an alternative embodiment of a shipping container.

FIGS. 5A-5C are directed to an alternative embodiment of a blank for forming an alternative embodiment of a shipping container.

FIG. 6 is directed to an alternative embodiment of a blank for forming an alternative embodiment of a shipping container.

FIG. 7 is directed to an alternative embodiment of a blank for forming an alternative embodiment of a shipping container.

FIG. 8 is directed to an alternative embodiment of a blank for forming an alternative embodiment of a shipping container.

FIGS. 9A-9D are directed to embodiments of patterns for a plurality of score lines that may be present in embodiments of shipping containers of the present disclosure.

FIGS. 10A-10C are directed to embodiments of profiles of the embodiments of the plurality of score lines as shown in FIGS. 9A-9D.

FIGS. 11A-11D are directed to embodiments partial side sectional views of lateral side edges of embodiments of shipping containers of the present disclosure.

FIG. 12A is directed to an alternative embodiment of a blank for forming an alternative embodiment of a shipping container.

FIG. 12B is directed to a lateral side edge of the alternative embodiment of the shipping container formed from the alternative embodiment of the blank as shown in FIG. 12A.

FIG. 13A illustrates a plan view of an embodiment of a packaging material.

FIG. 13B illustrates a perspective view of the packaging material of FIG. 13A.

FIG. 13C illustrates a cross-sectional view of the packaging material of FIGS. 13A and 13B taken along line 13C-13C as shown in FIG. 13A.

FIG. 13D illustrates a side view the packaging material of FIGS. 13A-13C.

FIG. 14 illustrates a perspective view of a roll of a material for use in forming packages.

FIG. 15 illustrates a portion of the material of FIG. 14.

FIG. 16 illustrates a cross-sectional view of the material of FIGS. 14 and 15 taken along line A-A in FIG. 15.

FIG. 17 illustrates a plan view of a material for use in forming packages.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures and components associated with shipping containers or forming shipping containers have not been described in detail to avoid unnecessarily obscuring the descriptions of the embodiments of the present disclosure.

The present disclosure is directed to embodiments of shipping containers (e.g., mailers, fluted mailers, flat envelopes, fluted envelopes, etc.). For example, in at least one embodiment, a recyclable, conformable shipping container includes an outer liner, a first corrugated medium adhered to the outer liner, and a second corrugated medium adhered to the outer liner. The first and second corrugated mediums are spaced apart from each other such that folding the outer liner forms the shipping container as well as forms an interior pocket of the shipping container. The interior pocket of the shipping container is lined with the corrugated mediums such that when a product is positioned or placed within the interior pocket, which is lined with first and second flutes, the first and second corrugated mediums, respectively, cushion, support, and protect the product. The first and second flutes cushion, support, and protect the product within the interior pocket when shipping the product to a consumer, a customer, or a buyer.

In one embodiment, when the shipping container is formed by folding the outer liner such that the first corrugated medium and the second corrugated medium face each other, first flutes of the first corrugated medium and second flutes of the second corrugated medium are offset relative to each other such that the first flutes nest within the second flutes and vice versa. For example, the first flutes include first peaks and first valleys, and the second flutes include second peaks and second valleys. The first peaks of the first flutes are received by the second valleys of the second flutes, and the second peaks of the second flutes are received by the first valleys of the first flutes due to this offset of the first flutes relative to the second flutes. This offset configuration of the first and second flutes of the first and second corrugated mediums, respectively, allows the shipping container to exhibit a reduction in overall thickness when compressed flat.

In some embodiments, the first and second corrugated mediums may be integral with each other such that the first and second corrugated mediums are made of a single, continuous material (e.g., paper or some other suitable recyclable material).

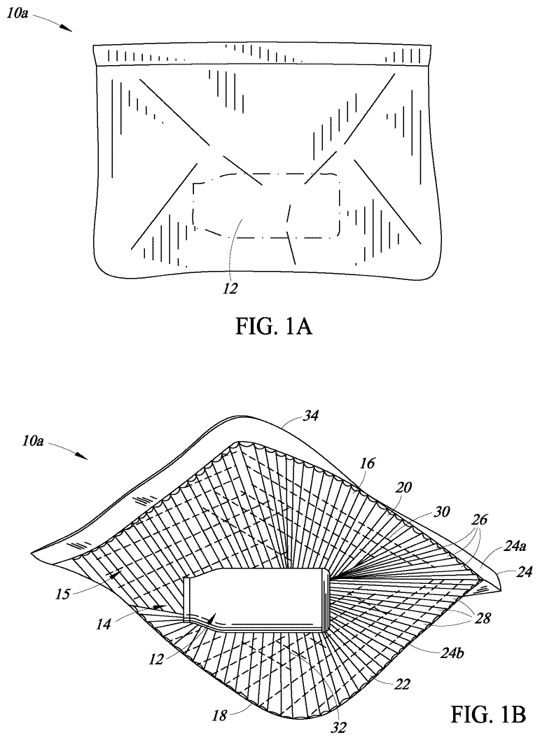

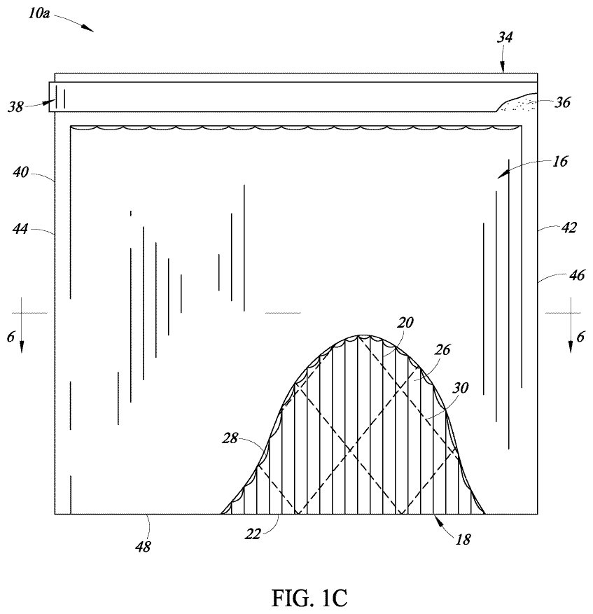

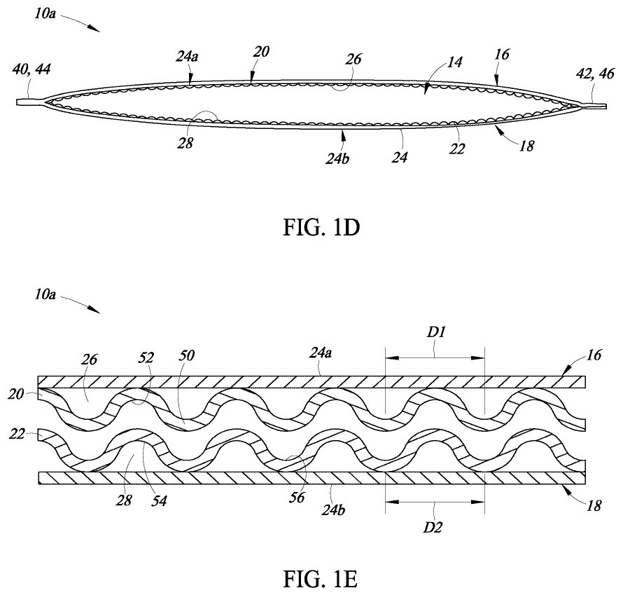

FIGS. 1A-1E are directed to an embodiment of a shipping container 10a in which a product 12 is positioned within an interior pocket 14 of the shipping container 10a. An opening 15 of the shipping container 10a provides access to the interior pocket 14 of the shipping container 10a. In other words, the opening 15 provides a user access to place the product 12 within the interior pocket 14 of the shipping container 10a.

The interior pocket 14 is positioned between a first panel 16 of the shipping container 10a and a second panel 18 of the shipping container 10a. The first panel 16 is opposite to the second panel 18. The first panel 16 includes a first corrugated medium 20 and a first portion 24a of an outer liner 24 to which the first corrugated medium 20 is adhered. The second panel 18 includes a second corrugated medium 22 and a second portion 24b of the outer liner 24 to which the second corrugated medium 22 is adhered. The first and second corrugated mediums 20, 22 may be adhered to the outer liner 24 by an adhesive, which may be a contact adhesive, a heat activated adhesive, or some other suitable type of adhesive for adhering the first and second corrugated mediums 20, 22 to the outer liner 24. The first corrugated medium 20, the second corrugated medium 22, the first portion 24a of the outer liner 24, and the second portion 24b of the outer liner 24 may be more readily and clearly seen in FIG. 1E. The corrugated mediums and the liner are formed from paperboard or linerboard.

In some embodiments, the first and second corrugated mediums 20, 22 are integral with each other and are made of a single, continuous material such that the first and second corrugated mediums 20, 22 are integrally coupled to each other. In some embodiments, the first and second corrugated mediums 20, 22 may be separate and distinct from each other.

In some embodiments, the first and second portions 24a, 24b of the outer liner 24 may be separate and distinct portions from each other. In some embodiments, the first and second portions 24a, 24b of the outer liner 24 are integral with each other and are made of a single, continuous material such that the first and second portions 24a, 24b are integrally coupled to each other.

The first corrugated medium 20 includes a plurality of first flutes 26 and the second corrugated medium 22 includes a plurality of second flutes 28. The plurality of first flutes 26 and the plurality of second flutes 28 are substantially the same size and shape as each other. In some embodiments, the plurality of first flutes 26 and the plurality of second flutes 28 may be different sizes and shapes (e.g., different heights, different widths, different lengths, etc.). Flutes of different widths are characterized by different distances between adjacent peaks or adjacent valleys of the corrugated medium. Flutes of different heights are characterized by different distances between a bottom of a valley and the top of a peak. The first and second flutes 26, 28 of the first and second corrugated mediums 20, 22 line the interior pocket 14 of the shipping container 10a. The first and second flutes 26, 28 of the first and second corrugated mediums 20, 22, respectively, cushion, support, and protect the product 12 within the interior pocket 14 when shipping the product to a consumer, a customer, or a buyer.

Respective adjacent peaks of the first and second flutes 26, 28 may be spaced apart by a distance ranging from 0.25 inches to 2 inches. For example, a first peak of one of the first flutes 26 is spaced apart from a second peak of another of the first flutes 26 adjacent to the first peak by a first distance ranging from 0.25 inches to 2 inches, and a third peak of one of the second flutes 28 is spaced apart from a fourth peak of another of the second flutes 28 adjacent to the third peak by a second distance ranging from 0.25 inches to 2 inches.

In some embodiments, the first distance may be equal to the second distance. In some embodiments the first distance may be different from the second distance.

The first corrugated medium 20 includes a plurality of first score lines 30, which are slits cut into the first flutes 26 or indentations or creases that are on the first flutes 26 of the first corrugated medium 20. When the plurality of first score lines 30 are slits, they extend through all or a portion of the first flutes 26 of the first corrugated medium 20. When the plurality of first score lines 30 are indentations or creases, they are formed through the entire height or a portion of the entire height of the first flutes 26. The plurality of first score lines 30 may be diagonally aligned, vertically aligned, horizontally aligned, or some other combination of directional alignment based on the orientation of the shipping container as shown in FIG. 1B. For example, the first score lines 30 may include a first group of the first score lines 30 that extend in a first direction and a second group of the first score lines 30 that extend in a second direction, which is transverse to the first direction. The first group of first score lines 30 may overlap with the second group of the first score lines 30 forming geometric shapes between the score lines 30 on the first flutes 26 of the first corrugated medium 20. The geometric shapes on the first flutes 26 are diamond shapes, which can be more readily seen in FIG. 1C. Embodiments in accordance with the present disclosure are not limited to geometric shapes that are diamond shaped. In other embodiments, the geometric shapes are different than diamond shaped.

The second corrugated medium includes a plurality of second score lines 32, which are slits cut into the second flutes 28 or indentations or creases that are on the second flutes 28 of the second corrugated medium 22. When the plurality of second score lines 32 are slits, they extend through all or a portion of the second flutes 28 of the second corrugated medium 22. When the plurality of second score lines 32 are indentations or creases, they are formed through the entire height or a portion of the entire height of the second flutes 28. The plurality of second score lines 32 may be diagonally aligned, vertically aligned, horizontally aligned, or some other combination of directional alignment based on the orientation of the package as shown in FIG. 1B. For example, the second score lines 32 may include a first group of the second score lines 32 that extend in a first direction and a second group of the second score lines 32 that extend in a second direction, which is transverse to the first direction. The first group of second score lines 32 may overlap with the second group of the second score lines 32 forming geometric shapes between the second score lines 32 on the second flutes 28 of the second corrugated medium 22. The geometric shapes on the second flutes 28 are diamond shapes, which can be more readily seen in FIG. 1C. Embodiments in accordance with the present disclosure are not limited to geometric shapes that are diamond shaped. In other embodiments, the geometric shapes are different than diamond shaped.

In some embodiments, the first and second score lines 30, 32 of the first and second corrugated mediums 20, 22, respectively, may be perforated score lines. In some embodiments, the first and second score lines 30, 32 of the first and second corrugated mediums 20, 22, respectively, may be non-perforated score lines. In some embodiments, the first and second score lines 30, 32 may be dotted score lines. In some embodiments, the first and second score lines 30, 32 may be continuous score lines.

The first and second score lines 30, 32 of the first and second corrugated mediums 20, 22, respectively, provide the first and second flutes 26, 28 of the first and second corrugated mediums 20, 22, respectively, with conformability, e.g., flexibility, such that the first and second flutes flex, fold, compress, and/or expand to conform to the product 12 when placed within the interior pocket 14 of the shipping container 10a. For example, when the product 12 contacts the first and second flutes 26, 28, the first and second flutes 26, 28 may flex, fold, compress, and/or expand in reaction to the product contacting the first and second flutes 26, 28 resulting in the first and second flutes 26, 28 more readily conforming to the shape of the product 12. In other words, the shipping container 10a conforms to the product 12 or differently shaped and sized products accordingly.

Respective adjacent score lines of the first and second score lines 30, 32 may be spaced apart by a distance ranging from 0.25 inches to 2 inches. For example, one of the first score lines 30 is spaced apart from another of the first score lines 30 adjacent to the one of the first score lines 30 by a first distance ranging from 0.25 inches to 2 inches, and one of the second score line 32 is spaced apart from another of the second score lines 32 is adjacent to the one of the second score lines 32 by a second distance ranging from 0.25 inches to 2 inches.

In some embodiments, the first distance may be equal to the second distance. In some embodiments the first distance may be different from the second distance.

A flap 34 of the outer liner 24 extends outward from the first portion 24a of the outer liner 24. The flap 34 is configured to cover the opening 15 closing off the interior pocket 14 when shipping the product 12 within the shipping container 10a. The flap 34 is integral with the first portion 24a of the outer liner 24 such that the flap is made of a single, continuous material with the first portion 24a of the outer liner 24.

In some embodiments, the flap 34 may be a separate and distinct portion of the shipping container 10a that is adhered or coupled to the first portion 24a of the outer liner 24 by an adhesive or by some other suitable coupling or adhesion technique.

As shown in FIG. 1C, an adhesive 36 is on the flap 34. The adhesive 36 may be a contact adhesive, a heat activated adhesive, or some other type of adhesive. The adhesive 36 is covered by a release liner 38. The adhesive 36 temporarily or removably couples the release liner 38 to the flap 34. When folding the flap 34 to cover the opening 15 closing off the interior pocket 14, a user pulls the release liner 38 off the adhesive 36, which exposes the adhesive 36. The flap 34 is then folded to contact the second portion 24b of the outer liner 24 such that the adhesive 36 adheres the flap 34 to the second portion 24b of the outer liner 24 closing off and covering the interior pocket 14 of the shipping container 10a to protect, cushion, and support the product 12 within the shipping container 10a when shipped to a customer, a consumer, or a buyer.

As shown in FIG. 1C, the first panel 16 includes a first lateral seal edge 40 at the left-hand side of FIG. 1C and a second lateral seal edge 42 at the second right-hand side of FIG. 1C, where the second lateral seal edge 42 is opposite to the first lateral seal edge 40. The second panel 18 includes a third lateral seal edge 44 at the left-hand side of FIG. 1C and a fourth lateral seal edge 46 at the right-hand side of FIG. 1C, where the fourth lateral seal edge 46 is opposite to the third lateral seal edge 44. The first and second lateral seal edges 40, 42 may be edges of the first portion 24a of the outer liner 24, and the third and fourth lateral seal edges 44, 46 may be edges of the second portion 24b of the outer liner 24. The first lateral seal edge 40 is adhered to the third lateral seal edge 44 by an adhesive, and the second lateral seal edge 42 is adhered to the fourth lateral seal edge 46 by an adhesive.

A fifth edge 48 is transverse to the first, second, third, and fourth lateral seal edges 40, 42, 44, 46 of the first and second panels 16, 18. The fifth edge 48 may be a fold line edge that separates the first portion 24a of the outer liner 24 from the second portion 24b of the outer liner 24. The fold line edge 48 may be a crease line, a scored line, or some other type of fold line to assist in folding the outer liner 24 about the fold line edge 48. The fold line edge 48 is an edge upon which the outer liner 24 is folded to align the first, second, third, and fourth lateral seal edges 40, 42, 44, 46 such that the first, second, third, and fourth lateral seal edges 40, 42, 44, 46 may be adhered together to form the shipping container 10a. For example, when the outer liner 24 is folded about the fifth edge 48, the first lateral seal edge 40 becomes aligned with and overlaps the third lateral seal edge 44 such that the first and third lateral seal edges 40, 44 may be adhered to each other. When the outer liner 24 is folded about the fifth edge 48, the second lateral seal edge 42 becomes aligned with and overlaps the fourth lateral seal edge 46 such that the second and fourth lateral seal edges 42, 46 may be adhered to each other.

FIG. 1D is a cross-sectional view taken about line 6-6 in FIG. 1C in which the product 12 is not present within the interior pocket 14 of the shipping container 10a.

FIG. 1E is a cross-sectional zoomed-in view of the first panel 16 and the second panel 18 when the shipping container 10a is in a compressed and flattened state to be shipped to a retailer in which the shipping container 10a will be later used by the retailer to ship a product.

As shown in FIG. 1E, the first flutes 26 each include a first peak 50 and a first valley 52. The distance between adjacent peaks 50 is a first distance D1. The first peaks 50 are spaced apart from each other by the first valleys 52. The distance between adjacent valleys 52 is a second distance D2. The first valleys 52 are spaced apart from each other by the first peaks 50. The second flutes 28 each include a second peak 54 and a second valley 56. The second peaks 54 are spaced apart from each other by the second valleys 56, and the second valleys 56 are spaced apart from each other by the second peaks 54. As shown in FIG. 1E, the first distance D1 is substantially equal to the distance D2 as the first flutes 26 are relatively the same size as the second flutes 28.

In some embodiments, the first flutes 26 may be differently shaped or sized than the second flutes 28 such that the first distance D1 is less than the second distance D2. In some embodiments, the first flutes 26 may be differently shaped or sized than the second flutes 28 such that the first distance D1 is greater than the second distance D2.

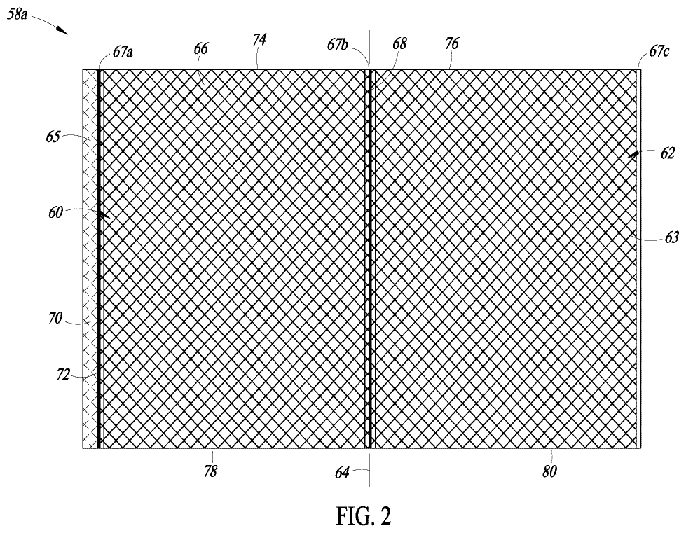

FIG. 2 is an embodiment of a blank 58a to form an embodiment of a shipping container. The blank 58a has features that are the same or similar as features of the shipping container 10a as shown in FIGS. 1A-1E. Accordingly, for the sake of simplicity and brevity of the present disclosure, the following description focuses on differences and additional features of the blank 58A with respect to the shipping container 10a as shown in FIGS. 1A-1E.

The blank 58a includes a first panel 60 and a second panel 62, which are similar to the first panel 16 and the second panel 18 as discussed with respect to FIGS. 1A-1E. The blank 58a includes a midline axis 64 that is at a halfway point of a support medium 66 of the blank 58a that separates the support medium 66 into two substantially equal halves.

The first panel 60 and the second panel 62 both include an outer liner 65 and a support medium 66 that is adhered to a surface of the outer liner 65. The support medium 66 includes a plurality of score lines 63, which are the same or similar as the plurality of scores lines 30, 32 as discussed with respect to FIGS. 1A-1E. While the support medium 66 is shown in FIG. 2 without flutes, in some embodiments, the support medium 66 may include flutes similar to the first and second flutes 26, 28 as discussed with respect to FIGS. 1A-1E.

The support medium 66 includes a plurality of crushed regions 67a, 67b, 67c. A first crushed region 67a is directly adjacent to an end of the support medium 66 closest to the left-hand side of FIG. 2, a second crushed region 67b is positioned between the first panel 60 and the second panel 62 at a location at which the first panel 60 meets the second panel 62, and a third crushed region 67c is at an end of the support medium closest to the right-hand side of FIG. 2. The crushed regions 67a, 67b, 67c reduce a thickness of a shipping container at these corresponding locations of the crushed regions 67a, 67b, 67c when the blank 58a is folded and utilized to form the shipping container. This reduced thickness of these crushed regions 67a, 67b, 67c as compared to thicknesses at other locations of the support medium 66 allows the blank 58a to be more readily and easily folded at these locations to form the shipping container from the blank 58a.

In some embodiments, the support medium 66 may be a corrugated medium. In some embodiments, the support medium 66 is a single, continuous piece of material and the outer liner 65 is a single, continuous piece of material. In some embodiments, the support medium 66 may be at least two separate and distinct corrugated mediums. In some embodiments, the support medium 66 may be a single, continuous corrugated medium with a first corrugated portion at the first panel 60 and a second corrugated portion at the second panel 62, and the first corrugated portion and the second corrugated portion are integrally coupled to each other.

A fold line 68 is positioned between the first panel 60 and the second panel 62. The fold line 68 is the same or similar as the fold line edge 48 as discussed with respect to FIGS. 1A-1E. The fold line 68 is adjacent to the midline axis 64.

A flap 70 is at an end of the outer liner 65 furthest away from the second panel 62. The flap 70 is the same or similar as the flap 34 as discussed with respect to FIGS. 1A-1E. However, unlike the flap 48 as discussed with respect to FIGS. 1A-1E, the flap 70 includes a fold line 72 about which the flap 70 is folded along for adhering an adhesive on the flap 70 to a portion of the outer liner 65 that makes up the second panel 62. When the flap is folded and adhered to the portion of the outer liner 65, the flap 70 closes off an interior pocket of the shipping container formed by the blank 58a. The fold line 72 allows a user to more readily adhere the flap 70 to the portion of the outer liner 65 that makes up the second panel 62 reducing the likelihood of poor adhesion between the flap 70 and the portion of the outer liner 65 that makes up the second panel 62.

The blank 58a includes lateral seal edges 74, 76, 78, 80, which are the same or similar as the lateral seal edges 40, 42, 44, 46 as discussed with respect to FIGS. 1A-1E. When the blank 58a is folded about the fold line 68, the first lateral seal edge 74, which is at the upper right-hand corner of FIG. 2, of the first panel 60 is adhered to a second lateral seal edge 76, which is at the upper left-hand corner of FIG. 2, of the second panel 62. When the blank 58a is folded about the fold line 68, a third lateral seal edge 78, which is at the lower left-hand corner of FIG. 2, of the first panel 60 is adhered to a fourth lateral seal edge 80, which is at the lower right-hand corner of FIG. 2, of the second panel 62. The lateral seal edges 74, 76, 78, 80 may be correspondingly adhered to each other by an adhesive in the same or similar manner as the lateral seal edges 40, 42, 44, 46 as discussed with respect to FIGS. 1A-1E.

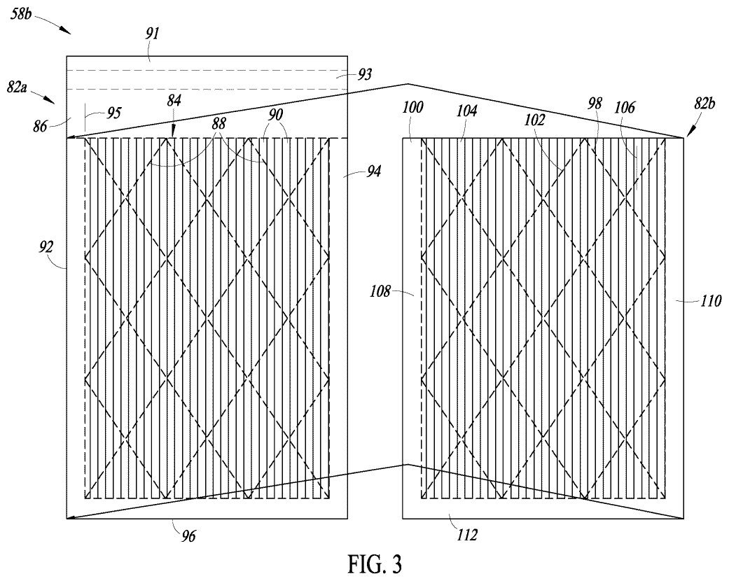

FIG. 3 is directed to an alternative embodiment of a blank 58b that is utilized to form an alternative embodiment of a shipping container. The blank 58b includes a first blank portion 82a, which is at the left-hand side of FIG. 3, and a second blank portion 82b, which is at the right-hand side of FIG. 3. The first blank portion 82a is larger than the second blank portion 82b.

The first blank portion 82a includes a first corrugated medium 84 adhered to a first outer liner 86. The first corrugated medium 84 is the same or similar as the first corrugated medium 20 as discussed with respect to FIGS. 1A-1E. However, unlike the first corrugated medium 20 as discussed with respect to FIGS. 1A-1E, a plurality of score lines 88 of the first corrugated medium 84 form larger diamond shape patterns on flutes 90 of the first corrugated medium 84. These diamond shape patterns on the flutes 90 are larger relative to those of the first corrugated medium 20 as shown in FIGS. 1A-1E. Each of the flutes 90 includes a corresponding longitudinal axis extending in the same direction as a line 95.

The first blank portion 82a includes a flap 91 of the outer liner 86 that extends away from the first corrugated medium 84. The flap 91 is the same or similar to the flap 34 as discussed with respect to FIG. 1A. Similar to the flap 34, the flap 91 includes a release liner 93 temporarily, removably, and releasably coupled to an adhesive on the flap 91. The release liner 93 is the same or similar as the release liner 38 as discussed with respect to FIGS. 1A-1E. The flap 91 is at the top side of the first blank portion 82a based on the orientation of the first blank portion 82a in FIG. 3.

The first blank portion 82a includes lateral seal edges 92, 94, 96 that are the same or similar as the lateral seal edges 40, 42, 44, 46 as discussed with respect to FIGS. 1A-1E. A first lateral seal edge 92 and a second lateral seal edge 94 are transverse to a third lateral seal edge 96. The first lateral seal edge 92 is on the left-hand side of the first blank portion 82a and the second lateral seal edge 94 is on the right-hand side of the first blank portion based on the orientation of the first blank portion 82a as shown in FIG. 3. The third lateral seal edge 96 is at the bottom side of the first blank portion 82a based on the orientation in FIG. 3. The first and second lateral seal edges 92, 94, respectively, extend from the third lateral seal edge 96 to the flap 91.

The second blank portion 82b includes a second corrugated medium 98 on a second outer liner 100. The second corrugated medium 98 is the same or similar as the second corrugated medium 22 as discussed with respect to FIGS. 1A-1E. However, unlike the second corrugated medium 22 as discussed with respect to FIGS. 1A-1E, a plurality of score lines 102 of the second corrugated medium 98 form diamond shape patterns on flutes 104 that are larger than those of the second corrugated medium 22 as discussed with respect to and shown in FIGS. 1A-1E. Each one of the flutes 104 includes a corresponding longitudinal axis that extends in the same direction as a line 106.

The longitudinal axes 106 at a peak of the flutes 104 of the second corrugated medium 98 of the second blank portion 82b are offset with respect to the longitudinal axes 95 of the flutes 90 of the first corrugated medium 84 of the first blank portion 82a. This offset between the longitudinal axes 95, 106 results in the flutes 90 of the first corrugated medium 84 of the first blank portion 82a nesting within the flutes 104 of the second corrugated medium 98 of the second blank portion 82b when forming the shipping container with the first and second blank portions 82a, 82b, respectively. This offset alignment can be more readily appreciated in view of FIG. 1E.

The second blank 82b includes lateral seal edges 108, 110, 112 that are the same or similar as the lateral seal edges 40, 42, 44, 46 as discussed with respect to FIGS. 1A-1E. A first lateral seal edge 108 and a second lateral seal edge 110 are transverse to a third lateral seal edge 112. The first lateral seal edge 108 is on the left-hand side of the second blank portion 82b and the second lateral seal edge 110 is on the right-hand side of the second blank portion 82b based on the orientation in FIG. 3. The third lateral seal edge 112 is at the bottom side of the second blank portion 82b based on the orientation in FIG. 3. The first and second lateral seal edges 108, 110 extend from third lateral seal edge 112 to an end of the second blank portion 82b opposite to the end at which the third lateral seal edge 112 is present.

When forming the shipping container utilizing the first blank portion 82a and the second blank portion 82b, the first lateral seal edge 92 of the first blank portion 82a is adhered to the second lateral seal edge 110 of the second blank portion 82b, the second lateral seal edge 94 of the first blank portion 82a is adhered to the first lateral seal edge 108 of the second blank portion 82b, and the third lateral seal edge 96 of the first blank portion 82a is adhered to the third lateral seal edge 112 of the second blank portion 82b. After the lateral seal edges 92, 94, 96, 108, 110, 112 of the first and second blank portions 82a, 82b, respectively, are adhered together, the release liner 93 is pulled off to expose the adhesive on the flap 91, and the flap 91 is adhered to the outer liner 100 of the second blank portion 82b. These lateral sealed edges may be adhered together by an adhesive such as a glue.

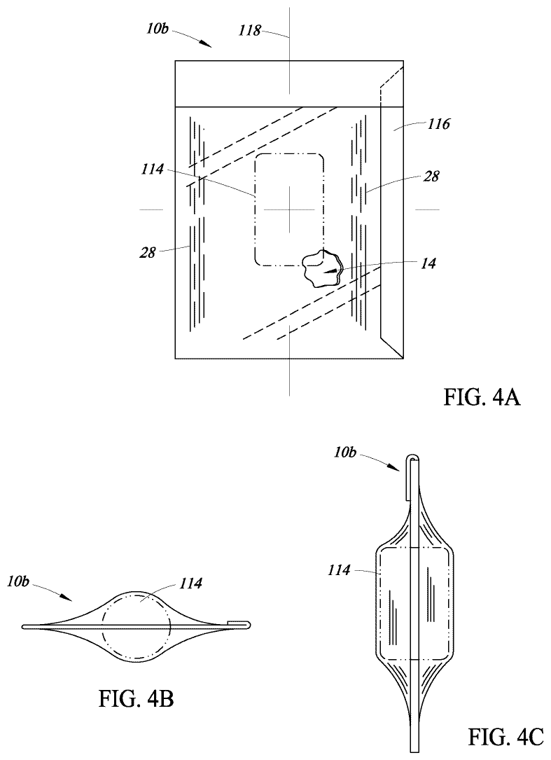

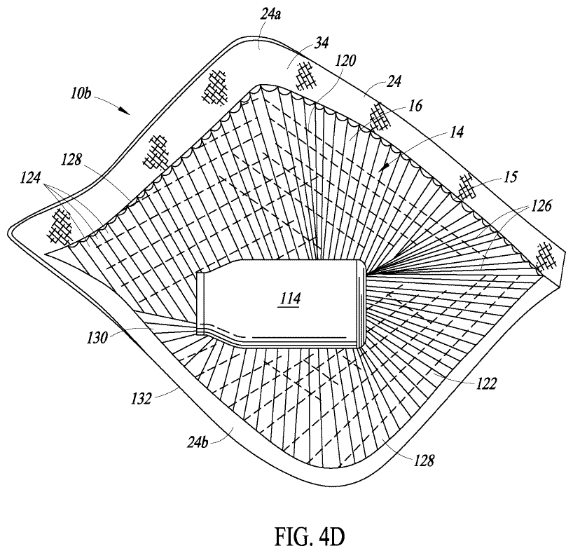

FIGS. 4A-4D are directed to an alternative embodiment of a shipping container 10b, which is the same or similar to the shipping container 10a as shown in FIGS. 1A-1E. Similar to the product 12 in the shipping container 10a as shown in FIGS. 1A-1D, a product 114 is positioned within the shipping container 10b as shown in FIGS. 4A-4D.

Unlike the shipping container 10a as shown in FIGS. 1A-1E, the shipping container 10b has a side flap 116 that wraps around the right-hand side of the shipping container 10b, as illustrated in FIG. 4A, and is adhered to the outer liner on the opposite side of the shipping container 10b. For example, the side flap 116 may be the same or similar as the flap 70 as shown in FIG. 2.

The shipping container 10b has a midline axis 118 that evenly splits the shipping container 10b into a first half on the right-hand side of the midline axis 118 and a second half on the left-hand side of the midline axis 118 (as illustrated in FIG. 4A). The height and width of the first half is substantially equal to the height and width of the second half.

Unlike the first corrugated medium 20 of the shipping container 10a, a first corrugated medium 120 as shown in FIG. 4D of the shipping container 10b has a plurality of first flutes 124 having a first width and a plurality of second flutes 126 having a second width that is less than the first width. The widths of a flute are described above with reference to FIGS. 1A-1E and is not repeated here in the interest of brevity. Unlike the second corrugated medium 22 of the shipping container 10b, a second corrugated medium 122 as shown in FIG. 4D of the shipping container 10b has a plurality of third flutes 128 of a third width and a plurality of fourth flutes 130 having a fourth width less than the third width.

In some embodiments, the first width is substantially equal to the third width and the second width is substantially equal to the fourth width. In some embodiments, the first width may be different than the third width and the second width may be different from the fourth width. In some embodiments, the first width, the second width, the third width, and the fourth width may be different from each other, may be substantially equal to each other, or may be related to each other in some other combination or manner.

Unlike the shipping container 10a as shown in FIGS. 1A-1E, the shipping container 10b as shown in FIG. 4D has a support flap 132 that extends outward from the second portion 24b of the outer liner 24. The support flap 132 provides support for an outer edge of the second panel 18 making access to the opening 15 more readily and easily accessible. The support flap 132 may reinforce the outer edge of the shipping container 10b when the shipping container has been closed utilizing the flap 34 to reduce the likelihood of the shipping container 10b accidentally opening when the shipping container 10b is utilized to ship the product 114.

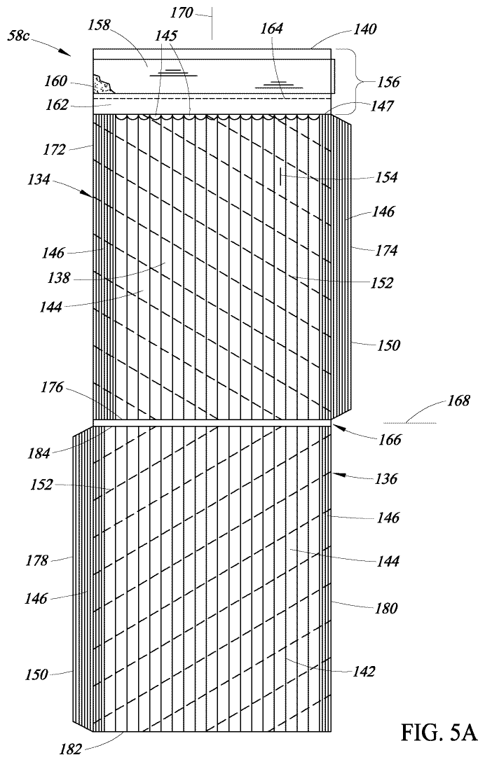

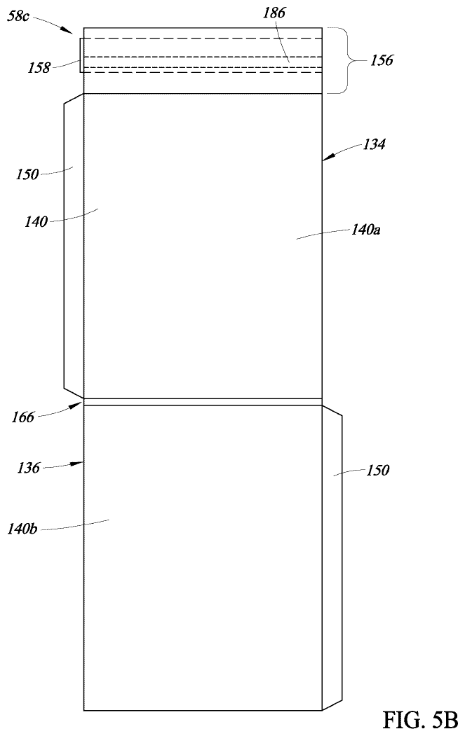

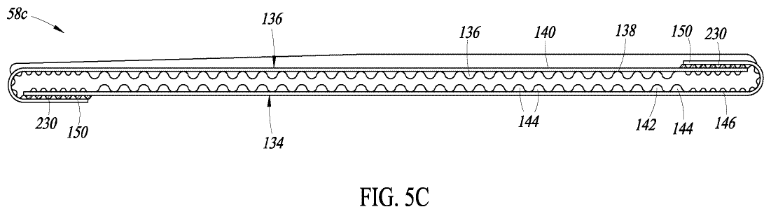

FIGS. 5A-5C are directed to a blank 58c that is similar as the blanks 58a, 58b as discussed earlier with respect to FIGS. 2 and 3.

As shown in FIG. 5A, the blank 58c includes a first panel 134 and a second panel 136. The first panel 134 is the same or similar as the first panel 16 of the shipping container 10a. The second panel 136 is the same or similar as the second panel 18 of the shipping container 10a.

The first panel 134 includes a first corrugated medium 138 and a first portion 140a in FIG. 5B of an outer liner 140. The second panel 136 includes a second corrugated medium 142 and a second portion 140b in FIG. 5B of the outer liner 140.

The first corrugated medium 138 includes first flutes 144 having a first width and second flutes 146 having a second width that is smaller than the first width. The first flutes 144 are larger, e.g., wider or higher/taller, than the second flutes 146. The first flutes 144 are positioned between a first group of the second flutes 146, which are at the left-hand side of the first panel 134 as shown in FIG. 5A, and a second group of the second flutes 146, which are at the left-hand side of the first panel 134 as shown in FIG. 5A. The second group of the second flutes 146 are on and at a side edge extension 150 that extends outward from the first panel 134. The first and second flutes 144, 146 are the same or similar as the flutes 126, 128 of the shipping container 10b as discussed with respect to FIGS. 4A-4D.

The first corrugated medium 138 includes a plurality of scores lines 152 on the first flutes 144 and the second flutes 146 that extend in a direction directed from the right-hand side of the first panel 134 to the left-hand side of the first panel 134 as illustrated in FIG. 5A. The score lines 152 are at an angle with respect to the right-hand side and the left-hand side of the first panel 134, as illustrated in FIG. 5A, such that the scores lines 152 are diagonal score lines.

The score lines 152 are the same or similar as the first and second score lines 30, 32 as discussed with respect to FIGS. 1A-1E. However, unlike the scores lines 30, 32, the score lines 152 form diagonal score lines and do not form diamond shape patterns on the first corrugated medium 138.

The functionality of the score lines 152 in combination with the flutes 144, 146 is substantially the same as the functionality of the score lines 30, 32 and the flutes 26, 28 of the shipping container 10a as discussed earlier with respect to FIGS. 1A-1E.

Each of the first and second flutes 144, 146 includes a longitudinal axis 154, and the longitudinal axes 154 of the first and second flutes 144, 146 are substantially parallel with each other. The first flutes 144 include first ends 145 and the second flutes 146 include second ends 147. The first ends 145 and the second ends 147 of the first and second flutes 144, 146, respectively, are adjacent to a flap 156 of the outer liner 140.

The flap 156 of the outer liner 140 extends outward and away from the first corrugated medium 138. The flap 156 of the blank 58c is the same or similar to the flap 34 of the shipping container 10a as discussed earlier with respect to FIGS. 1A-1E.

The flap 156 includes a release liner 158 that covers an adhesive 160 on the flap 156. The release liner 158 is the same or similar as the release liner 38 of the shipping container 10a as discussed earlier with respect to FIGS. 1A-1E, and the adhesive 160 is the same or similar to the adhesive 36 of the shipping container 10a as discussed earlier with respect to FIGS. 1A-1E.

However, unlike the flap 34 of the shipping container 10a as shown in FIGS. 1A-1E, the flap 156 includes an extension portion 162 that spaces the release liner 158 further away from the first corrugated medium 138 as compared to a distance the release liner 38 is spaced apart from the first corrugated medium 20 as shown in FIGS. 1A-1E. When the flap 156 is closed to close a shipping container formed by the blank 58c as shown in FIGS. 5A-5C, the extension portion 162 provides a higher likelihood of properly adhering the flap 156 to the second portion 140b of the outer liner 140.

In some embodiments, the release liner 158 and the adhesive 160 may extend onto the extension portion 162 such that the surface area of the release liner 158 and the adhesive 160 is larger as compared to a surface area of the release liner 158 and the adhesive 160 as shown in FIGS. 5A-5C. The increased surface area of the adhesive 160 increases the strength and robustness of a physical connection between the flap 156 and the second portion 140b of the outer liner 140 reducing the likelihood the shipping container formed by the blank 58c opens when shipping a product within the shipping container.

Unlike the flap 34 of the shipping container 10a as shown in FIGS. 1A-1E, the flap 156 includes a fold line 164 that extends from a first side of the flap 156 to a second side of the flap 156, which is opposite to the first side. The fold line 164 assists when folding the flap 156 to close off a shipping container formed by the blank 58c when shipping a product within the shipping container formed by the blank 58c.

The blank 58c includes a fold line 166 at a location at which the first panel 134 meets the second panel 136. The fold line 166 is at a location at which the first portion 140a of the outer liner 140 meets the second portion 140b of the outer liner 140. The fold line 166 is about a horizontal axis 168, as illustrated in FIG. 5A, which passes between the first corrugated medium 138 and the second corrugated medium 142.

The blank 58c includes a vertical axis 170, which is transverse to the horizontal axis 168, as illustrated in FIG. 5A. The vertical axis 170 may be a centerline axis of the blank 58c, as illustrated in FIG. 5A. The vertical axis 170 may be perpendicular to the horizontal axis 168, as illustrated in FIG. 5A.

The first panel 134 includes a first lateral seal edge 172 at the left-hand side of the first panel 134 as illustrated in FIG. 5A and a second lateral seal edge 174 at the right-hand side of the first panel 134 as illustrated in FIG. 5A. The first corrugated medium includes a third edge 176 that extends to the first and second lateral seal edges 172, 174. For example, the third edge 176 extends from the first lateral seal edge 172 to the second lateral seal edge 174.

The second panel 136 is a mirror image of the first panel 134 flipped about the vertical axis 170, as illustrated in FIG. 5A. The second panel 136 is the same or similar as the first panel 134 except for being the mirror image of the first panel 134 flipped about the vertical axis 170, as illustrated in FIG. 5A. Accordingly, for simplicity and brevity of the present disclosure, only differences or additional features of the second panel 136 will be discussed herein with respect to the first panel 134.

Unlike the first panel 134, the second panel 136 includes a fourth lateral seal edge 178 at the left-hand side of FIG. 5A, a fifth lateral seal edge 180 at the right-hand side of FIG. 5A, and a sixth edge 182 at an end of the second panel 136 furthest away from the first panel 134. The second corrugated medium includes a seventh edge 184 adjacent to the third edge 176 of the first corrugated medium 138. The seventh edge 184 is spaced apart from the third edge 176. The sixth edge 182 and the seventh edge 184 are transverse to the fourth lateral seal edge 178 and the fifth lateral seal edge 180. The sixth edge 182 and the seventh edge 184 extend from the fourth lateral seal edge 178 to the fifth lateral seal edge 180. For example, the sixth edge 182 extends from the fourth lateral seal edge 178 to the fifth lateral seal edge 180, and the seventh edge 184 extends from the fourth lateral seal edge 178 to the fifth lateral seal edge 180.

In some embodiments, the first corrugated medium 138 and the second corrugated medium 142 are integral with each other such that the first corrugated medium 138 and the second corrugated medium 142 are made of a single, continuous material. When the first and second corrugated mediums 138, 142 are integral with each other, the third edge 174 and the seventh edge 184 are not present, and instead, the first and second corrugated mediums 138, 142 are integrally coupled to each other by a portion extending from the first corrugated medium 138 to the second corrugated medium 142. The portion covers the fold line 166 such that when folding the blank 58c to form a shipping container, the portion between the first and second corrugated mediums 138, 142 is folded with the outer liner 140 along the horizontal axis 168 based on the orientation in FIG. 5A.

When forming a shipping container utilizing the blank 58c, the side edge extension 150 of the first panel 134 wraps around the fifth lateral seal edge 180 of the second panel 136 and the second lateral seal edge 174 is adhered to the second portion 140b of the outer liner 140, and the side edge extension 150 of the second panel 136 wraps around the first lateral seal edge 172 of the first panel 134 and the fourth lateral seal edge 178 is adhered to the first portion 140a of the outer liner 140.

Similar to the first and second flutes 126, 128 as shown in FIG. 4D that have different widths, the first and second flutes 144, 146 have different widths like the first and second flutes 126, 128. The first flutes 144 have a first width and the second flutes 146 have a second width that is less than the first width. The first flutes 144 are taller than the second flutes 146. This difference in the heights and widths of the first and second flutes 144, 146 can be more readily appreciated in view of FIG. 5C.

As shown in FIG. 5C, the second flutes 146 are less tall and wide than the first flutes 144. The second flutes 146 being less tall and wide than the first flutes 144 allow the side edge extensions 150 of the first and second panels 134, 136 to more readily wrap around a corresponding one of the lateral seal edges 172, 180, respectively, and be adhered to the first and second portions 140a, 140b, respectively, of the outer liner 140. For example, the less tall and wide second flutes 146 allow the side edge extensions 150 to be more easily folded reducing stress on an adhesive 230 that is utilized to adhere the side edge extensions 150 to the outer liner as compared to the second flutes 146 had the same height and width as the first flutes 144. If the second flutes 146 had the same height and width as the larger first flutes 144, the second flutes 146 would more readily pull away from the adhesive 230 increasing the likelihood of the side edge extensions 150 becoming detached from the outer liner 140.

As shown in FIG. 5B, the flap 156 of the outer liner 140 includes a tear strip 186. When the tear strip 186 is pulled and torn off, the tear strip 186 is removed and the tear strip 186 detaches a portion of the flap 156 that has been adhered to the second portion 140b of the outer liner 140 allowing a consumer, a customer, or a buyer to access an interior pocket of the shipping container formed by the blank 58c. In other words, the tear strip 186 allows a customer, a consumer, or a buyer access a product shipped within the shipping container formed from the blank 58c.

The results of this forming of a shipping container from the blank 58c can be readily seen in FIG. 5C, and the structure of the shipping container formed by the blank 58c is readily apparent in view of the earlier discussion with respect to FIGS. 5A and 5B. As in other embodiments, flutes of first corrugated medium 138 can be offset from the flutes of the second corrugated medium 142 when the shipping container of FIGS. 5A-5C is constructed.

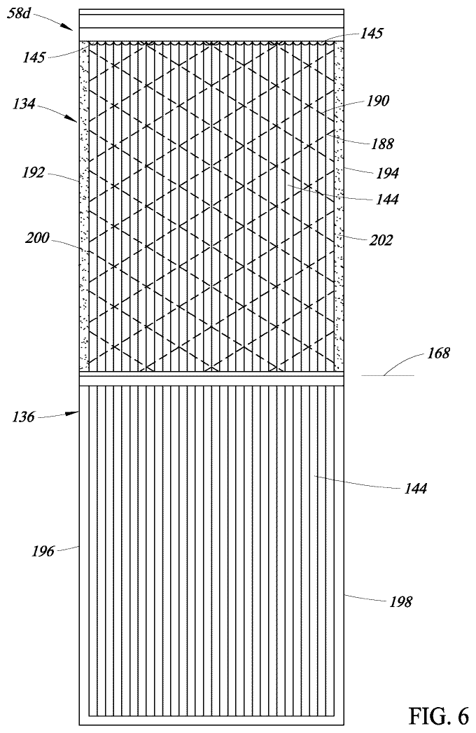

FIG. 6 is directed to a blank 58d that is utilized to form a shipping container. The blank 58d is the same as or similar to the blank 58c discussed earlier with respect to FIGS. 5A-5C. Accordingly, for the sake of simplicity and brevity of the present disclosure, the present description focuses on different or additional features of the blank 58d with respect to the blank 58c as shown in FIGS. 5A-5C. As in other embodiments, flutes of corrugated medium of panel 134 can be offset from the flutes of the corrugated medium of panel 136 when the shipping container of FIG. 6 is constructed.

Unlike the blank 58c, a first panel 134 of the blank 58d includes a plurality of first score lines 188 being at a first angle and a plurality of second score lines 190 at a second angle. The first score lines 188 and the second score lines 190 overlap each other forming a diamond-shaped pattern on flutes 144 of the first panel 134. A second panel 136 of the blank 58d does not include any score lines. However, in some embodiments, the second panel 136 may include score lines similar to the embodiment of the blank 58b as shown in FIG. 5A.

The blank 58d includes a first lateral seal edge 192 at the left-hand side of the first panel 134 as shown in FIG. 6. The blank 58d includes a second lateral seal edge 194 at the right-hand side of the first panel 134 as shown in FIG. 6. The blank 58d includes a third lateral seal edge 196 at the left-hand side of the second panel 136 as shown in FIG. 6. The blank 58d includes a fourth lateral seal edge 198 at the right-hand side of the second panel 136 as shown in FIG. 6.

A first adhesive layer 200 is on and covers the first lateral seal edge 192 of the first panel 134, and a second adhesive layer 202 is on and covers the second lateral seal edge 194 of the first panel 134. The first adhesive layer 200 adheres the first lateral seal edge 192 to the third lateral seal edge 196, and the second adhesive layer 202 adheres the second lateral seal edge 194 to the fourth lateral seal edge 198 when utilizing the blank 58d to form a shipping container.

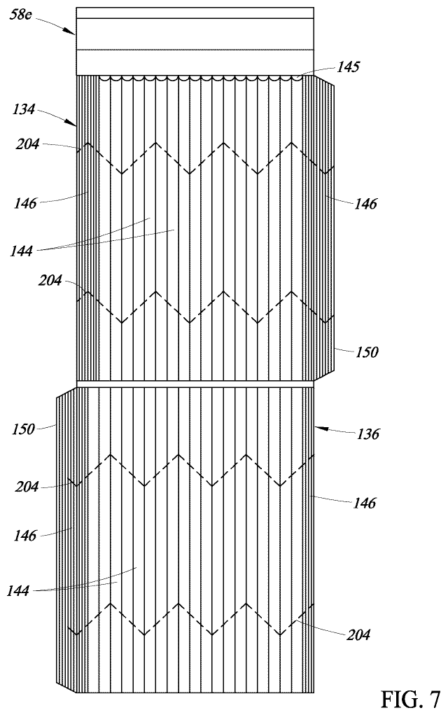

FIG. 7 is directed to an alternative embodiment of a blank 58e that is the same or similar as the blank 58c as shown in FIGS. 5A-5C. Accordingly, only differences or additional features of the blank 58e will be discussed in further detail with respect to the blank 58c as shown in FIGS. 5A-5C.

Unlike the blank 58c, the blank 58e has score lines 204 on flutes 144, 146 of a first and second panel 134, 136, respectively, that have a zig-zag pattern. The score lines 204 function in the same or similar manner as the score lines 30, 32 as discussed with respect to FIGS. 1A-1E.

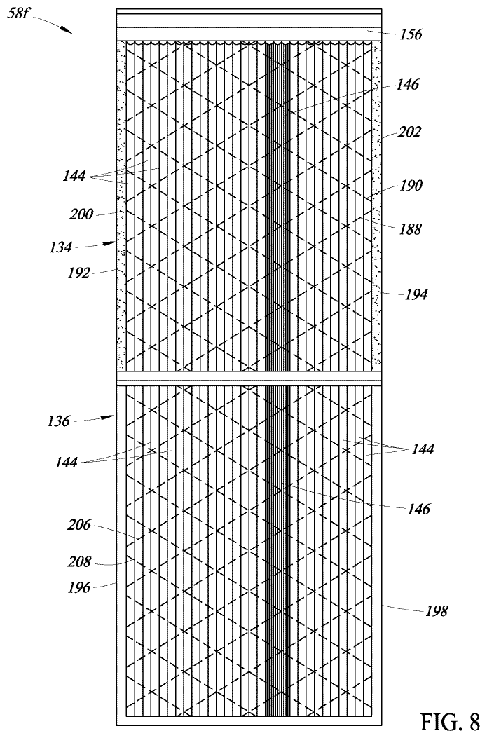

FIG. 8 is directed to an alternative embodiment of a blank 58f that is the same or similar as the blank 58c as shown in FIGS. 5A-5C and the blank 58d as shown in FIG. 6. In other words, the blank 58f includes some of the same or similar features as the blank 58c in combination with some of the same or similar features as the blank 58d. Accordingly, this description focuses on differences or additional features of the blank 58f with respect to the blank 58d as shown in FIG. 6.

Unlike the blank 58d, the blank 58f includes first flutes 144 that have a first width and a first height that are on the left-hand side and the right-hand side of second flutes 146, as illustrated in FIG. 8, that have a second width and a second height that are less than the first width and the first height, respectively. The second flutes 146 are positioned closer to a center line of the blank 58f relative to the second flutes 146 of the blank 58c as shown in FIG. 5A and the blank 58e as shown in FIG. 7.

Unlike the blank 58d, the blank 58f has a plurality of first score lines 188 and a plurality of second score lines 190 that cross over and overlap each other forming a diamond shaped patterns on flutes 144, 146 of the first panel 134. The blank 58f includes a plurality of third score lines 206 and a plurality of fourth score lines 208 that cross over and overlap each other forming diamond shaped patterns on flutes 144, 146 of the second panel 136. The diamond shaped patterns on the first panel 134 are smaller as compared to the diamond shaped patterns on the second panel 136.

The second flutes 146 being centrally located between the first flutes 144 allow a shipping container formed by the blank 58f to be more readily conformable to a product within the shipping container. For example, the second flutes 146 being smaller and less high will have greater foldability, flexibility, and bendability relative to the larger first flutes 144. Therefore, the second flutes 146 will more readily conform to a product positioned within an interior pocket of the shipping container formed from the blank 58f as compared to if only the first flutes 144 were present and the second flutes 146 were not present.

The location of the second flutes 146, which are smaller in height and width as compared to the first flutes 144, may be preselected based on a shape or size of a product that is regularly shipped by a retailer. In other words, the location of the second flutes 146 is customizable to be tailored for a specific shape and size of a specific product such that the shipping container formed from the blank 58f will more readily conform to the specific shape and size of the specific product as compared to another shipping container that is not customized for the specific shape and size of the specific product.

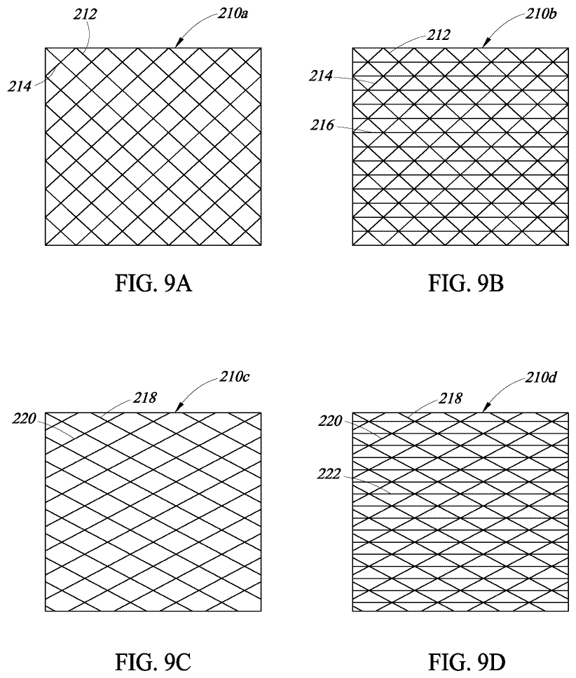

FIGS. 9A-9D are directed to embodiments of patterns formed by score lines on either a first panel or a second panel of embodiments of blanks or shipping containers of the present disclosure.

As shown in FIG. 9A, a first scoring pattern 210a includes first scoring lines 212 and second scoring lines 214. The first scoring lines 212 and the second scoring lines 214 are transverse to each other such that the first scoring lines 212 and the second scoring lines 214 overlap and cross over forming a diamond shaped pattern. The first scoring lines 212 and the second scoring lines 214 may be transverse to each other by an angle of 90 degrees such that the diamonds are rotated squares. The diamond shaped pattern includes a plurality of diamonds.

As shown in FIG. 9B, a second scoring pattern 210b includes first scoring lines 212 and second scoring lines 214, which are the same or similar as the first scoring lines 212 and the second scoring lines 214 as previously discussed with respect to FIG. 9A.

The second scoring pattern 210b includes third scoring lines 216 that are horizontal based on the orientation of the second scoring pattern 210b as shown in FIG. 9B. The first, second, and third scoring lines 212, 24, 216 overlap and cross over forming a triangular shaped pattern. The triangular shaped pattern includes a plurality of triangles.

As shown in FIG. 9C, a third scoring pattern 210c includes first scoring lines 218 and second scoring lines 220. The first scoring lines 218 and the second scoring lines 220 are transverse to each other such that the first scoring lines 218 and the second scoring lines 220 overlap and cross over forming a diamond shaped pattern. The first scoring lines 218 and the second scoring lines 220 may be transverse to each other by an angle greater than 90 degrees. The diamond shaped pattern includes a plurality of diamonds.

Unlike the diamond shaped patterns in FIG. 9A, the diamond shaped patterns as shown in FIG. 9C are rotated parallelograms or diamonds instead of rotated squares as the first scoring lines 218 and the second scoring lines 220 are at an angle relative to each other that is greater than 90 degrees.

As shown in FIG. 9D, a fourth scoring pattern 210d includes first scoring lines 218 and second scoring lines 220, which are the same or similar as the first scoring lines 218 and the second scoring lines 220 as previously discussed with respect to FIG. 9C. The fourth scoring pattern 210d includes third scoring lines 222 that are horizontal based on the orientation of the fourth scoring pattern 210d as shown in FIG. 9D. The first, second, and third scoring lines 218, 220, 222 overlap and cross over forming a triangular shaped pattern. The triangular shaped pattern includes a plurality of triangles.

Unlike the triangular shaped pattern as shown in FIG. 9B, the triangular shaped pattern in FIG. 9D has triangles that are wider than the triangles in the triangular shaped pattern as shown in FIG. 9B.

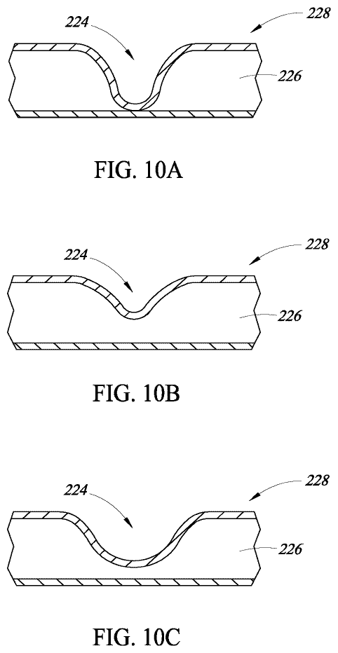

FIGS. 10A-10C are directed to end profiles of at least three non-perforated score lines 224 formed in a flute 226 in a corrugated medium 228. In FIGS. 10A-10C, the length of the flute extends left to right. It should be understood that the present disclosure is not limited to these score line patterns or profiles. In some embodiments, the score lines 224 may be perforated score lines. The profiles of the score lines 224 may be profiles of score lines in various embodiments of shipping containers and blanks to form the shipping containers as disclosed within the present disclosure or within the scope of the present disclosure.

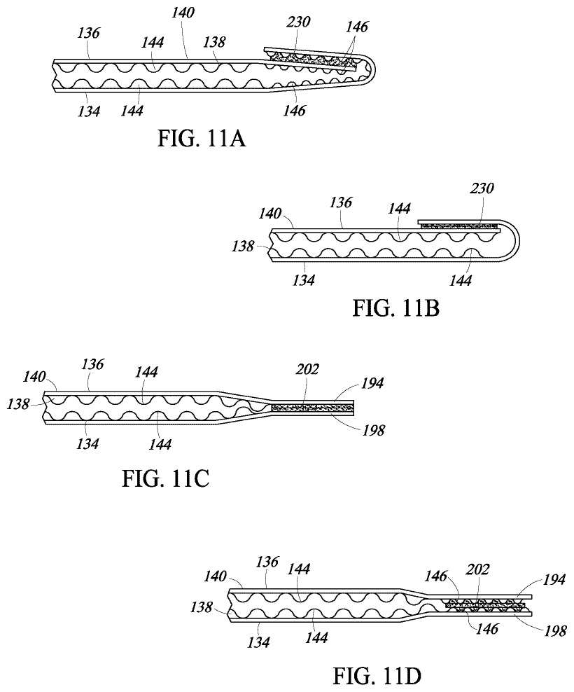

FIGS. 11A-11D are directed to embodiments of seals formed between a first panel 134 and a second panel 136 of embodiments of blanks that are coupled together to form a shipping container from the embodiments of the blanks as disclosed within the present disclosure.

FIG. 11A is a depiction of how the side edge extension 150 is wrapped around the fifth lateral seal edge 180 to adhere the second lateral seal edge 174 to the second portion 140b of the outer liner 140 of the blank 58a as shown in FIG. 5A. An adhesive 230 couples second flutes 146 to the outer liner 140.

FIG. 11B is a depiction of how the side edge extension 150 is wrapped around the fifth lateral seal edge 180 to adhere the second lateral seal edge 174 to the second portion 140b of the outer liner 140 of the blank 58a as shown in FIG. 5A. However, unlike FIG. 11A, the flutes 146 are not present. Instead, in FIG. 11B, an adhesive 230 couples an inner surface of an end of the first panel 134 to a portion of the outer liner 140 of the second panel 136.

FIG. 11C is a depiction of how the second lateral seal edge 194 of the first panel 134 is adhered to the fourth lateral seal edge 198 of the second panel 136 of the blank 58d. The adhesive 202 couples the first lateral seal edge 192 of the first panel 134 to the fourth lateral seal edge 198 of the second panel 136.

FIG. 11D is a depiction of how the second lateral seal edge 194 of the first panel 134 is adhered to the fourth lateral seal edge 198 of the second panel 136 of the blank 58d. However, unlike FIG. 11C, flutes 146 are on inner surfaces of ends of the second lateral seal edge 194 and the fourth lateral seal edge 198. The adhesive 202 couples the flutes 146 at the inner surfaces of the ends of the second lateral seal edge 194 and the fourth lateral seal edge 198 to each other.

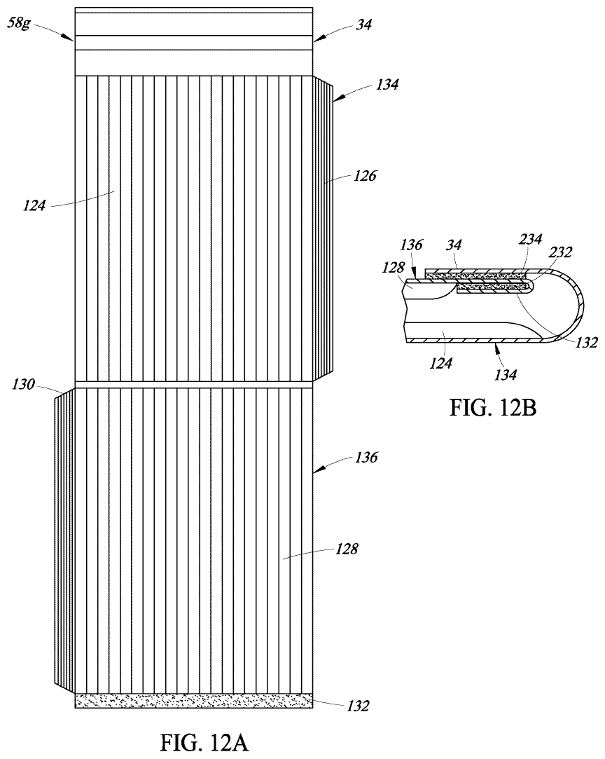

FIGS. 12A and 12B are directed to forming an alternative embodiment of a shipping container utilizing a blank 58g, which may be the blank 58g that is utilized for forming the shipping container 10b as shown in FIGS. 4A-4D.

As shown in FIG. 12A, the blank 58g includes a flap 34 that is the same or similar as the flap 34 as shown in FIGS. 4A-4D, the flutes 124, 126, 128, 130 are the same or similar as the flutes 124, 126, 128, 130 as shown in FIGS. 4A-4D, and a support flap 132 that is the same as the support flap 132 as shown in FIGS. 4A-4D.

As shown in FIG. 12B, a first portion of the support flap 132 is folded over and attached to an inner surface of a second portion of the support flap 132. The first portion of the support flap 132 is adhered to the inner surface of the second portion of the support flap 132 by an adhesive 232. The flap 34 is folded over and coupled to the second panel 136 by an adhesive 234, and when the flap 34 is folded over and coupled to the second panel 136, the interior pocket 15 is closed off by the flap 34, which covers the product 114 within the shipping container 10b as shown in FIG. 4D.

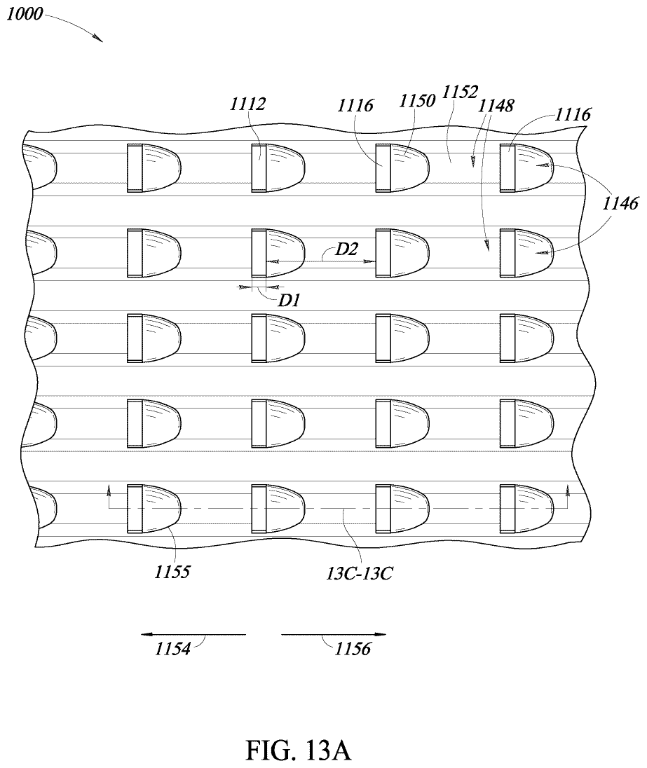

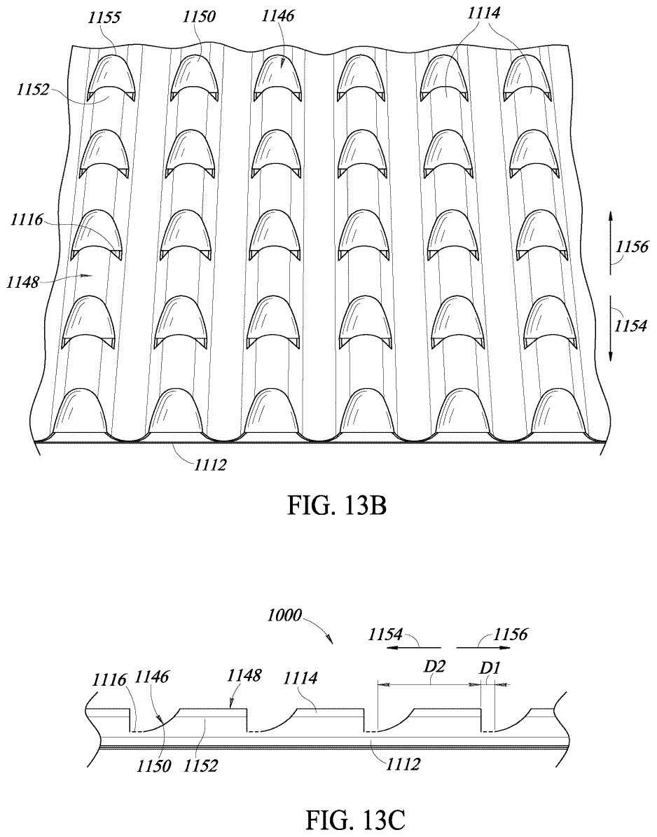

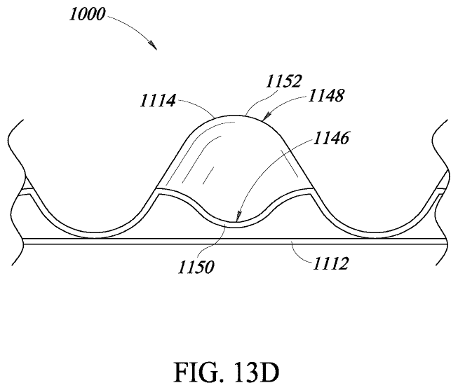

FIGS. 13A-13D illustrate a packaging material 1000. The packaging material 1000 may have many features in common with other packaging materials described elsewhere herein. The packaging material 1000 includes a plurality of slits 1116 that extend through flutes of a corrugated layer thereof. The corrugated layer, including the slits 1116, is configured to provide conformability while also providing protection and cushioning, as described elsewhere herein. The plurality of slits 1116 define a plurality of sub-flutes 1114, and the sub-flutes 1114 are configured to function similar to bubbles of a bubble mailer.

A first dimension D1 of the plurality of slits 1116 extends between adjacent ones of the plurality of sub-flutes 1114, and a second dimension D2 of the plurality of sub-flutes 1114 extends between adjacent ones of the plurality of slits 1116. The first dimension D1 may be ½-inches, ¼-inches, ⅛-inches, 1/16-inches, or may be some other dimension of the plurality of slits 1116. The first dimension D1 may be less than the second dimension D2. However, in some alternative embodiments, the first dimension D1 may be greater than the second dimension D2 such that the plurality of slits 1116 may be larger than the plurality of sub-flutes 1114.

The packaging material 1000 includes a plurality of surfaces 1146 and a plurality of curved surfaces 1148. Each one of the plurality of surfaces 1146 is a corresponding surface of a crushed portion or a compressed portion 1150 of a corresponding one of the plurality of sub-flutes 1114. In some embodiments, the plurality of surfaces 1146 may be flat surfaces, may be concave surfaces, may be convex surfaces, may be partially concave surfaces, may be partially flat surfaces, may be partially concave surfaces, or may be some other combination of these various types of surfaces that may be part of the crushed or compressed portion 1150. For example, in some alternative embodiments of the packaging material 1000, each one of the plurality of surfaces 1146 may include a peripheral portion that extends around a central portion, and the peripheral portion may be convex while the central portion may be concave (e.g., an indentation, dimple, compression, etc.). In these alternative embodiments, the peripheral portion may be arced and extend from the central portion to a corresponding one of the plurality of curved surfaces 1148 at which the peripheral portion of the surface 1146 meets the corresponding curved surface 1148 at a corresponding one of rounded edges 1155. In other words, the peripheral portions of the plurality of surfaces 1146 may have a torus-like profile while the central portions of the plurality of surfaces may have a hemispherical-like profile (e.g., indentation, dimple, etc.).

Each one of the plurality of curved surfaces 1148 is a corresponding surface of a raised portion or suspended portion 1152 (e.g., bubble portion) of a corresponding one of the plurality of sub-flutes 1114. Each one of the plurality of raised portions 1152 is adjacent to a corresponding one of the plurality of crushed portions 1150. The plurality of raised portions 1152 may cushion or protect a product when within a package formed including the plurality of sub-flutes 1114. In some embodiments, when the plurality of surfaces 1146 are relatively flat, an angle between the plurality of surfaces 1146 and the plurality of curved surfaces 1148 may be at an angle equal to 45-degrees, at an angle less than 45-degrees, or at some other suitable or selected angle.

Each one of the plurality of surfaces 1146 is a concave surface and is adjacent to a corresponding one of the plurality of slits 1116 such that each one of the plurality of the surfaces 1146 is between one of the plurality of slits 1116 and one of the plurality of raised portions 1152. Each one of the plurality of surfaces 1146 has a first end at the corresponding one of the plurality of slits 1116 and a second end at the corresponding one of the plurality of raised portions 1152. The first end of each one of the plurality of surfaces 1146 is in closer proximity to the outer liner layer 1112 than the second end of each one of the plurality of surfaces 1146. The plurality of curved surfaces 1148 are convex surfaces. The plurality of surfaces 1146 have a parabolic-like shape or profile.

When the packaging material 1000 is used to form a package, a first arrow 1154 represents a first direction directed from a folded edge of the package towards an opening of the package, and a second arrow 1156 represents a second direction directed from the opening of the package towards folded edge.

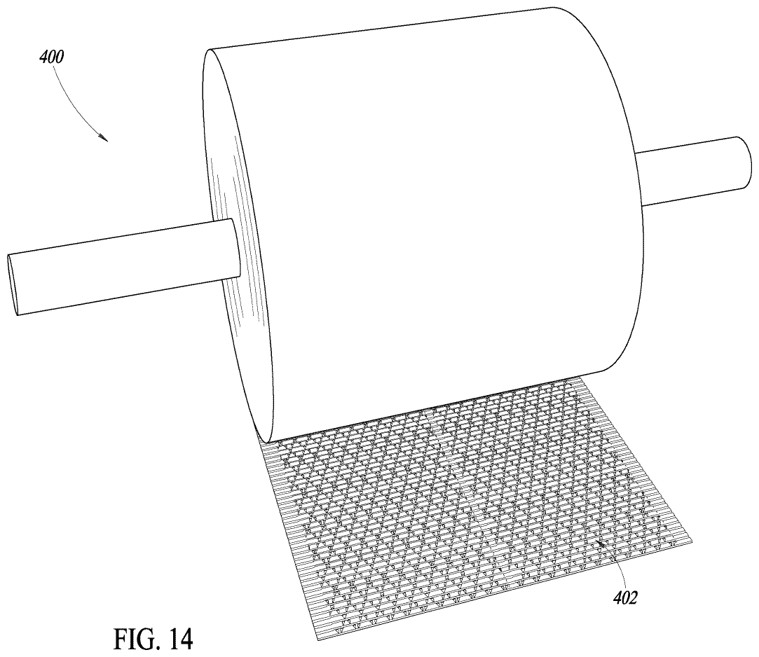

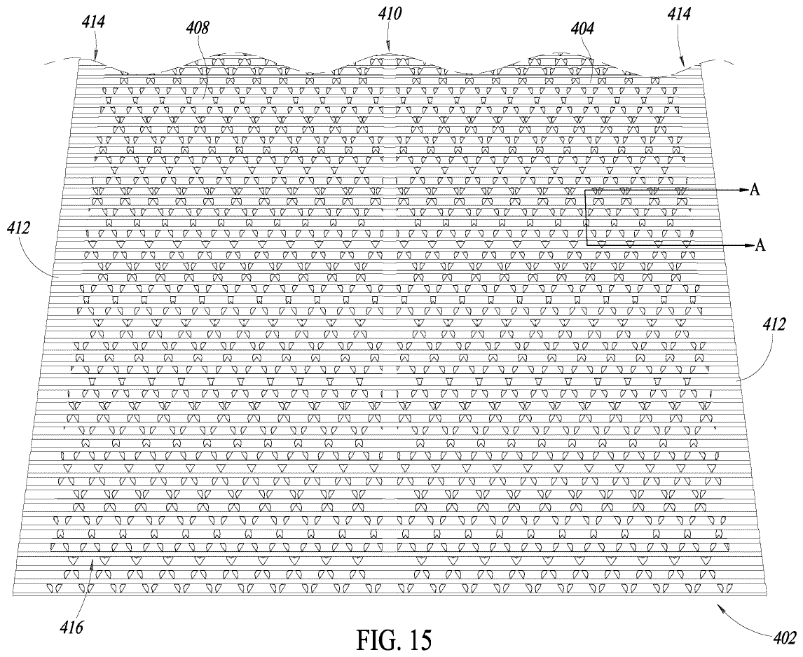

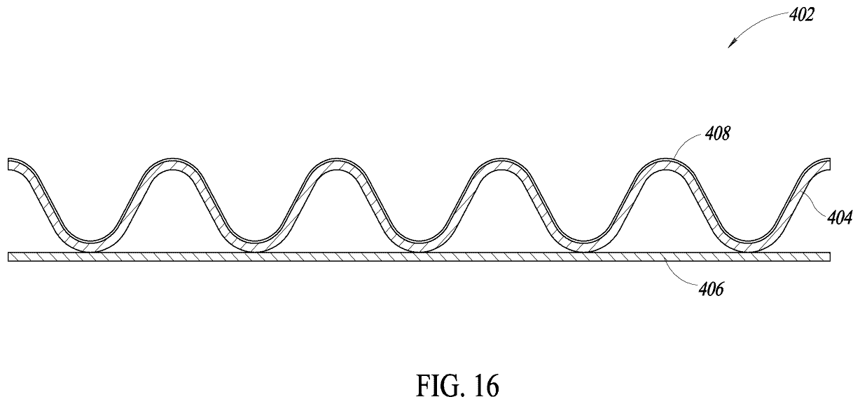

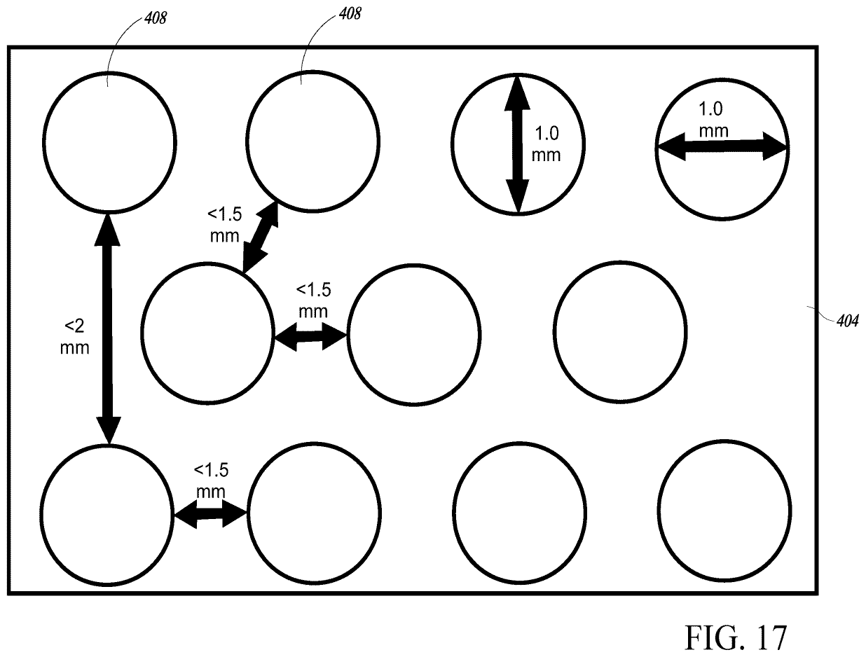

FIG. 14 illustrates a roll 400 of a material 402 for use in forming a package. FIG. 15 illustrates a portion of the material 402. FIG. 16 illustrates a cross-sectional view of the material 402. As illustrated in FIGS. 14-16, the material 402 comprises a single-faced corrugated material, such as a single-faced corrugated paperboard, linerboard, cardboard, paper, or other similar material. The material 402 can include features of any of the other materials described elsewhere herein, including the corrugated mediums described elsewhere herein, and can be used, in combination with other features described herein, to form any of the packages described herein, to the extent such combinations and modifications are physically achievable.

As illustrated in FIG. 16, the material 402 includes a corrugated medium 404 and an outer liner 406 to which the corrugated medium 404 is coupled, such as adhered. The corrugated medium 404, which may form a web or flutes of the material 402, may be adhered to the outer liner 406 by an adhesive, which may be a contact adhesive, a heat-activated adhesive, or some other suitable type of adhesive for adhering the corrugated medium 404 to the outer liner 406. In some embodiments, the adhesive may be a thermally-activated adhesive, a pressure-activated adhesive, a thermally-and pressure-activated adhesive, or some other type of adhesive or glue. The adhesive may be selected and utilized such that the material 402 remains recyclable, compostable, biodegradable, and/or re-pulpable as a complete unit even when the material 402 is not broken down before being placed, for example, within a recycling receptacle or container or within a composting receptacle or container. The corrugated medium 404 and/or the outer liner 406 may be formed from paperboard, linerboard, cardboard, or paper. As further illustrated in FIG. 16, the material 402 includes a layer of a water-based heat seal coating 408 applied to the outer surface of the corrugated medium 404 opposite to the outer liner 406. In some embodiments, the water-based heat seal coating 408 can be a polyvinyl alcohol (PVOH)-based heat seal coating, a polyvinyl acetate (PVA)-based heat seal coating, styrene acrylic-based heat seal coating, or a latex-based heat seal coating.

In some embodiments, the material 402 can be formed by applying the water-based heat seal coating 408 to the corrugated medium 404 by spraying, brushing, rolling, Mayer rod coating, roll coating, gravure coating, slot die application, etc. In some embodiments, the material 402 can be formed by applying the water-based heat seal coating 408 to the corrugated medium 404 using a reverse roll coater and associated techniques or flexographic printing, flexography, lithographic printing, or digital printing. In some embodiments, the material 402 can be formed by applying the water-based heat seal coating 408 to the corrugated medium 404 either before or after the corrugated medium 404 is corrugated and applied, coupled, or adhered to the outer liner 406.

In some embodiments, the water-based heat seal coating 408 covers the entire outer surface of the corrugated medium 404 opposite to the outer liner 406, across an entire length and width thereof. That is, the water-based heat seal coating 408 can cover the entirety of the outer surfaces of the flutes of the single-faced corrugated material 402, including peaks and valleys thereof, and including scored and unscored or crushed and uncrushed portions thereof. In some embodiments, however, the water-based heat seal coating 408 does not coat an entirety of the surface of the corrugated material opposite to the outer liner, and is zone-coated on the surface of the corrugated material opposite to the outer liner. In some embodiments, the water-based heat seal coating 408 coats peaks of the corrugated medium 404 of the single-faced corrugated material 402 and does not coat valleys of the corrugated medium 404 of the single-faced corrugated material 402. In other embodiments, the water-based heat seal coating 408 coats valleys of the corrugated medium 404 of the single-faced corrugated material 402 and does not coat peaks of the corrugated medium 404 of the single-faced corrugated material 402.

FIG. 15 illustrates that the corrugated medium 404 can have crushed portions and score lines formed therein. For example, as illustrated in FIG. 15, the corrugated medium 404 can have a 5-point center score 410 formed therein, such as by rolling a 5-point roller along the flutes to crush the flutes in this region. As illustrated in FIG. 15, the 5-point center score 410 extends along the longest dimension of the material 402, and parallel to side edges 412 thereof. As another example, as illustrated in FIG. 15, the corrugated medium 404 can have edge crushed regions 414 adjacent to the side edges 412 of the material 402 formed therein, such as by rolling wheels or rollers along the flutes to crush the flutes in this region. As illustrated in FIG. 15, the edge crushed regions 414 extend along the longest dimension of the material 402. As a further example, as illustrated in FIG. 15, the corrugated medium 404 can have a diamond score pattern 416 formed across an entire width and length of the material 402, such as by rolling diamond-shaped features of rollers across the entirety of the fluted surface of the material 402.

In some embodiments, the water-based heat seal coating 408 covers the entire outer surface of the corrugated medium 404 opposite to the outer liner 406, across an entire length and width thereof, except that it does not cover the 5-point center score 410, and/or the edge crush regions 414, and/or the diamond-patterned score lines 416. In other embodiments, the water-based heat seal coating 408 covers only the 5-point center score 410, and/or the edge crush regions 414, and/or the diamond-patterned score lines 416, and does not cover any other portions of the entire outer surface of the corrugated medium 404 opposite to the outer liner 406, across an entire length and width thereof. In one specific embodiment, the water-based heat seal coating 408 can cover the entirety of the outer surfaces of the flutes of the single-faced corrugated material 402, including peaks and valleys thereof, and including the edge crush regions 414 and the diamond patterned score lines 416, except that it does not cover the 5-point center score 410.

As illustrated in FIG. 14, the material 402 can be rolled up into the roll 400, such as for storage and shipping. In particular, the material 402 can be rolled up with the single-faced corrugated material or web thereof rolled inside. That is, when rolled up into the roll 400, the corrugated medium 404 is rolled on the inside and the outer liner 406 is rolled on the outside of the roll 400. As further illustrated in FIG. 14, longitudinal axes of the center score line 410 and the edge crushed regions 414 are aligned with the side edges 412 of the material 402, such that the center score line 410 and the edge crushed regions 414 extend along the entire length of the material 402 from the end of the material 402 at the radial center of the roll 400 to the opposite end of the material 402 at an outer surface of the roll 400. The length of the material 402 rolled up into the roll 400 can be at least 10, 20, 30, 40, 50, 60, 70, 80, 90, or 100 feet.

The material 402 can be fed into automated packaging machines to pack goods for shipping, such as from commercial distribution centers to end consumers. When the material 402 is used in this way, the material 402 can be fed into an automated packaging machine and folded in half along the center score line 410, such that the water-based heat seal coating 408 and the corrugated medium 404 are on the inside and the outer liner 406 is on the outside of the folded-over material 402. The presence of the center score line 410 makes it easier for the material 402 to be folded over in half by the automated packaging machine. The two halves of the material 402 can then be pinched or held together along two axes parallel to one another and perpendicular to the center score line 410, with an item to be shipped held within the folded-over material 402 and between the locations at which the folded-over material 402 is pinched.

Heat and pressure can be applied to the material 402 along these two axes and at the locations where the folded-over material 402 is pinched, as well as along the side edges 412 of the material, which now overlay one another at a location opposite to the center score line 410, to activate the water-based heat seal coating 408 to seal the material 402 to itself along the two axes and at the locations where the folded-over material 402 is pinched and along the edge crushed regions 414 thereof. The presence of the edge crushed regions 414 can improve the quality of a seal at the locations thereof. Such a process seals flutes of the material 402 to other flutes of the material 402 and does not seal anything to the outer liner 406. Such a process also seals the item to be shipped within the material 402. The portion of the material 402 within which the item is sealed can then be cut or separated from the rest of the material 402 to form an enclosed package, such as for shipping to an end user of the item. The center score line 410, the edge crushed regions 414, and the diamond score pattern 416 can generally make such a package more bendable or conformable.

The entirety of the material 402 can be natural fiber-based (e.g., paper) and/or water based, and the corrugated medium 404 and the outer liner 406 can include no plastic materials, such that the material 402 is entirely re-pulpable and recyclable. The corrugated medium 404 and the outer liner 406 may be made from recyclable, biodegradable, and/or re-pulpable materials that may be plant-based materials, fiber-based materials, and/or pulp-based materials (e.g., cotton, flax, wood, hemp, etc.). In some embodiments, the corrugated medium 404 and the outer liner 406 may be made from the same material(s), and the recipient of a package formed from the material 402 can throw the package directly into a recycling bin to properly recycle the package without breaking the package down beforehand.

As noted elsewhere herein, in some embodiments, the material 402 can be formed by applying the water-based heat seal coating 408 to the corrugated medium 404 using a reverse roll coater and associated fabrication techniques. Reverse roll coaters and their use in applying wet coatings are known in various other technical fields. It has been found that using reverse roll coating to apply the water-based heat seal coating 408 as described herein at targeted coat weights can result in an “orange peel” effect, which is understood in various other technical fields, such as painting, to be a coating defect.

For example, in some embodiments, the material 402 can be formed by applying the water-based heat seal coating 408 to the corrugated medium 404 using a reverse roll coater and associated fabrication techniques with a coat weight of at least 1, 2, 3, 4, 5, or 6 grams per square meter and/or no more than 5, 6, 7, 8, 9, or 10 grams per square meter (such coat weights being understood as “dry” weights). In some embodiments, such a coat weight results in only some portions of the surface of the corrugated medium 404 carrying the coating 408, with such portions taking on an orange-peel geometry and appearance. In some embodiments, the orange-peel geometry and appearance can resemble patterns such as Perlin noise, Simplex noise, or Worley, Voronoi, or cellular noise. For example, in some embodiments, such techniques can result in at least 5, 10, 15, 20, 25, 30, 35, 40, 45, or 50%, and/or no more than 30, 35, 40, 45, 50, 55, 60, 65, 70, 72, 75, or 80% of the surface of the corrugated medium being coated by the coating 408. In some specific embodiments, such techniques result in between 25% and 72% of the surface of the corrugated medium being coated by the coating 408. In one specific embodiment, such techniques result in 25% or about 25% of the surface of the corrugated medium being coated by the coating 408.

Nevertheless, experimental testing has shown that such application of the coating 408 is sufficient to meet design requirements, such as strength of a heat sealed bond formed between layers of a package fabricated as described herein. Thus, by reducing the coat weight of the coating 408, such techniques can improve overall efficiency of the materials and packages described herein. Furthermore, such a reduced coat weight can further improve the sustainability, recyclability, repulpability, and/or compostability of the materials and packages described herein.

As also noted elsewhere herein, in some embodiments, the material 402 can be formed by applying the water-based heat seal coating 408 to the corrugated medium 404 using flexography. Flexographic printing and its use in applying wet coatings is known in various other technical fields. It has been found that using flexography to apply the water-based heat seal coating 408 as described herein at targeted coat weights can allow the application of the coating 408 in specific patterns that can further improve overall performance and efficiency of the materials and packages described herein.

For example, as illustrated in FIG. 17, flexographic printing can be used to apply the coating 408 to the corrugated medium 404 in dots or circles, such as in a hexagonal arrangement. For example, in the hexagonal arrangement illustrated in FIG. 17, each dot or circle of the coating 408 may have a diameter of 1.0 mm and be spaced apart from adjacent dots by 1.5 mm, about 1.5 mm, or less than 1.5 mm. In other embodiments, the dots of the coating 408 may have diameters of at least 0.8, 0.9, 1.0, 1.1, or 1.2 mm, and/or no more than 1.7, 1.8, 1.9, 2.0, or 2.1 mm. In other embodiments, the dots are spaced apart from adjacent dots by at least 0.7, 0.8, 0.9, 1.0, or 1.1 mm, and/or no more than 1.3, 1.4, 1.5, 1.6, or 1.7 mm.

In some embodiments, the material 402 can be formed by applying the water-based heat seal coating 408 to the corrugated medium 404 using flexography with a coat weight of at least 1, 2, 3, 4, 5, or 6 grams per square meter and/or no more than 5, 6, 7, 8, 9, or 10 grams per square meter (such coat weights being understood as “dry” weights). In some embodiments, such techniques can result in at least 5, 10, 15, 20, 25, 30, 35, 40, 45, or 50%, and/or no more than 30, 35, 40, 45, 50, 55, 60, 65, 70, 72, 75, or 80% of the surface of the corrugated medium being coated by the coating 408. In some specific embodiments, such techniques result in between 25% and 72% of the surface of the corrugated medium being coated by the coating 408. In one specific embodiment, such techniques result in 25% or about 25% of the surface of the corrugated medium being coated by the coating 408. For example, in at least some embodiments, the water-based heat seal coating 408 is capable of being formed at respective weights selected from a range of 1-10 grams per square meter, or equal to the upper and lower ends of this range.

In some specific embodiments, the water-based heat seal coating 408 has a coat weight ranging from 4 to 5 grams per square meter. In some specific embodiments, the water-based heat seal coating 408 has an average coat weight of 4.5 grams per square meter. In other embodiments the water-based heat seal coating has a coat weight ranging from 3-6 grams per square meter or a coat weight ranging from 2-7 grams per square meter.

While FIG. 17 illustrates that the coating 408 can be applied to the surface of the corrugated medium 404 in dots, in other embodiments, the coating 408 can be applied in various other geometric patterns, such as ovals, ellipses, triangles, squares, etc. In some embodiments, the coating 408 can be applied in lines, such as in parallel lines extending along the corrugated medium, such as parallel to, perpendicular to, and/or oblique to the flutes of the corrugated medium 404. In some embodiments, the coating 408 can be applied in lines transverse to one another, such as in a rectilinear grid or in a diamond pattern. In some embodiments, the coating 408 can be applied in other patterns, such as in the shape of a corporate name or logo.

As described herein, the coating 408 can be applied to less than the entire outer surface of the corrugated material 404 opposite to the outer liner 406. Such embodiments have various advantages, including enhanced runnability on corrugator machinery, improved recyclability and repulpability, and cost effectiveness. Furthermore, the corrugated material 404 can be made of a porous material, such that coating only a portion of the outer surface of the corrugated material 404 with the coating 408 allows the corrugated material 404 to retain its porous characteristics (and maintains breathability of packages made therefrom). Additionally, coated regions of the corrugated material 404 are raised relative to uncoated regions thereof, such that a product sliding in contact with the coated surface of the corrugated material 404 may only contact the coated portions thereof, reducing overall friction between the product and the coated corrugated material 404. Further, applying less coating 408 reduces the application of water and related drying processes, and can provide a relatively efficient technique for fabricating extensible or stretchable materials without complications associated with wrinkling. One additional advantage of reducing the coat weight of the coating 408 is that a larger share of the coating 408 remains at the surface of the corrugated material 404, which is especially the case for flexography, and which can improve heat sealing performance and efficiency.

In some embodiments, the material 402 can be used to form a package as described herein by sealing two surfaces of the material 402 coated by the coating 408 to one another. In other embodiments, the material 402 can be used to form a package as described herein by sealing one surface of the material 402 coated by the coating 408 to another surface of the material 402 that is not coated by the coating 408.

As discussed earlier, the present disclosure is directed to at least one embodiment of a shipping container that includes at least a corrugated medium having a plurality of flutes adhered to an outer liner. The corrugated medium and outer liner are configured to be selectively bent and folded in directions aligned and not aligned with flutes of the corrugated medium. This bendability or flexibility of the corrugated medium with the flutes enables the corrugated medium and the outer liner to easily and closely conform to a product placed adjacent to the corrugated medium. In other words, the shipping container of the present disclosure readily conforms to the shape of the product.

In some embodiments, to provide the shipping container of the present disclosure with the bendability, foldability, and, ultimately, conformability, such that the shipping container of the present disclosure more readily conforms to a product, the corrugated medium may have a plurality of score lines that extend along, across, and through the plurality of flutes of the corrugated medium. These scoring lines increase the bendability, the flexibility, the foldability, and the conformability of the flutes and the shipping containers of the present disclosure as a whole.

This greater bendability, foldability, and conformability allows the shipping containers of the present disclosure to readily conform to a product positioned within the shipping containers of the present disclosure. This ability of the shipping containers of the present disclosure to conform to the shape of the products placed in the shipping containers reduces the shipping costs of the product. For example, a first total volume of the product and one of the shipping containers of the present disclosure in which the product is present is less than a second total volume of the same product in shipping containers that does not implement embodiments of the present disclosure. Therefore, shipping the product in one of the shipping containers of the present disclosure costs less than shipping the same product in shipping containers that does not implement embodiments of the present disclosure.

At least one embodiment of a system of the present disclosure is summarized as including: a single-faced corrugated material including a corrugated medium coupled to an outer liner; wherein a surface of the corrugated material opposite to the outer liner is coated by a water-based heat-seal coating.

In at least one embodiment, the corrugated medium includes a center score line.

In at least one embodiment, the corrugated medium includes edge score lines.

In at least one embodiment, the corrugated medium includes a diamond score pattern.

In at least one embodiment, the corrugated medium includes slits through the corrugated medium.

In at least one embodiment, the single-faced corrugated material is made from paper materials.

In at least one embodiment, the corrugated medium and the outer liner do not include any plastic materials.

In at least one embodiment, the water-based heat-seal coating has an array of shapes that are present along the surface of the corrugated material opposite to the outer liner.

In at least one embodiment, the water-based heat-seal coating is zone coated on the surface of the corrugated material opposite to the outer liner layer.

In at least one embodiment, the array of shapes is at least one of the following of circles, ovals, ellipses, triangles, or squares.

At least one embodiment of a package of the present disclosure is summarized as including: a sheet of a single-faced corrugated material including a corrugated medium coupled to an outer liner, wherein a surface of the corrugated material opposite to the outer liner is coated by a water-based heat-seal coating, wherein the sheet is folded along a fold line to form a first layer on a first side of the fold line and a second layer on a second side of the fold line, and wherein the fold line forms a first edge of the package; wherein the first layer is sealed to the second layer by the water-based heat seal coating along a second edge of the package, a third edge of the package, and a fourth edge of the package.

In at least one embodiment, a first portion of the corrugated medium is coupled to a second portion of the corrugated medium at the second edge of the package, a third portion of the corrugated medium is coupled to a fourth portion of the corrugated medium at the third edge of the package, and a fifth portion of the corrugated medium is coupled to a sixth portion of the corrugated medium at the fourth edge of the package.

In at least one embodiment, the corrugated medium includes a center score line and the fold line extends along the center score line.

In at least one embodiment, the corrugated medium includes edge score lines and the edge score lines are at the third edge of the package, wherein the third edge of the package is opposite to the first edge of the package.

In at least one embodiment, the corrugated medium includes a diamond score pattern.

In at least one embodiment, flutes of the corrugated medium include slits through the corrugated medium.

In at least one embodiment, the single-faced corrugated material is made from paper materials.

In at least one embodiment, the corrugated medium and the outer liner do not include any plastic materials.

At least one embodiment of a system of the present disclosure is summarized as including: a roll of a single-faced corrugated material including a corrugated medium coupled to an outer liner; wherein a surface of the corrugated material opposite to the outer liner is coated by a water-based heat-seal coating.

In at least one embodiment, an entirety of the surface of the corrugated material opposite to the outer liner is coated by the water-based heat-seal coating.

In at least one embodiment, the water-based heat seal coating does not coat an entirety of the surface of the corrugated material opposite to the outer liner, wherein the water-based heat seal coating is zone-coated on the surface of the corrugated material opposite to the outer liner.

In at least one embodiment, the single-faced corrugated material has an overall length of at least ten feet.

In at least one embodiment, the single-faced corrugated material has an overall length of at least fifty feet.

In at least one embodiment, the single-faced corrugated material has an overall length of at least one hundred feet.

In at least one embodiment, the water-based heat seal coating has an array of shapes that are present along the surface of the corrugated material opposite to the outer liner.

In at least one embodiment, the water-based heat seal coating is zone coated on the surface of the corrugated material opposite to the outer liner layer.

In at least one embodiment, the array of shapes is at least one of the following of circles, ovals, ellipses, triangles, or squares.

U.S. Provisional Application No. 63/580,635 filed on Sep. 5, 2023, and U.S. Provisional Application No. 63/597,609 filed on Nov. 9, 2023, are incorporated herein by reference in their entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A system, comprising:
a single-faced corrugated material including a corrugated medium coupled to an outer liner;
wherein a surface of the corrugated material opposite to the outer liner is coated by a water-based heat-seal coating.

2. The system of claim 1 wherein the corrugated medium includes a center score line.

3. The system of claim 1 wherein the corrugated medium includes edge score lines.

4. The system of claim 1 wherein the corrugated medium includes a diamond score pattern.

5. The system of claim 1 wherein flutes of the corrugated medium include slits through the corrugated medium.

6. The system of claim 1, further comprising one or both of:
said single-faced corrugated material is made from paper materials; and
said corrugated medium and said outer liner do not include any plastic materials.

7. (canceled)

8. A package, comprising:
a sheet of a single-faced corrugated material including a corrugated medium coupled to an outer liner, wherein a surface of the corrugated material opposite to the outer liner is coated by a water-based heat-seal coating, wherein the sheet is folded along a fold line to form a first layer on a first side of the fold line and a second layer on a second side of the fold line, and wherein the fold line forms a first edge of the package;
wherein the first layer is sealed to the second layer by the water-based heat seal coating along a second edge of the package, a third edge of the package, and a fourth edge of the package.

9. The package of claim 8 wherein a first portion of the corrugated medium is coupled to a second portion of the corrugated medium at the second edge of the package, a third portion of the corrugated medium is coupled to a fourth portion of the corrugated medium at the third edge of the package, and a fifth portion of the corrugated medium is coupled to a sixth portion of the corrugated medium at the fourth edge of the package.

10. The package of claim 8 wherein the corrugated medium includes a center score line and the fold line extends along the center score line.

11. The package of claim 8 wherein the corrugated medium includes edge score lines and the edge score lines are at the third edge of the package, wherein the third edge of the package is opposite to the first edge of the package.

12. The package of claim 8, further comprising at least one of:
said corrugated medium includes a diamond score pattern;
said flutes of the corrugated medium include slits through the corrugated medium;
said single-faced corrugated material is made from paper materials; and
said corrugated medium and said outer liner do not include any plastic materials.

13-15. (canceled)

16. A system, comprising:
a roll of a single-faced corrugated material including a corrugated medium coupled to an outer liner;
wherein a surface of the corrugated material opposite to the outer liner is coated by a water-based heat-seal coating.

17. The system of claim 16 wherein an entirety of the surface of the corrugated material opposite to the outer liner is coated by the water-based heat-seal coating.

18. The system of claim 16 wherein the water-based heat seal coating does not coat an entirety of the surface of the corrugated material opposite to the outer liner, wherein the water-based heat seal coating is zone-coated on the surface of the corrugated material opposite to the outer liner.

19. The system of claim 16 wherein the single-faced corrugated material has an overall length of at least ten feet, at least fifty feet, or at least one hundred feet.

20-21. (canceled)

22. The system of claim 16 wherein the water-based heat seal coating has an array of shapes that are present along the surface of the corrugated material opposite to the outer liner.

23. The system of claim 22 wherein the water-based heat seal coating is zone coated on the surface of the corrugated material opposite to the outer liner layer.

24. The system of claim 22 wherein the array of shapes is at least one of the following of circles, ovals, ellipses, triangles, or squares.

25. The system of claim 1 wherein the water-based heat-seal coating has an array of shapes that are present along the surface of the corrugated material opposite to the outer liner.

26. The system of claim 25 wherein the water-based heat-seal coating is zone coated on the surface of the corrugated material opposite to the outer liner layer.

27. The system of claim 25 wherein the array of shapes is at least one of the following of circles, ovals, ellipses, triangles, or squares.
